(19) United States
(12) Patent Application Publication
(10) Pub. No.: US 2021/0070041 A1
(43) Pub. Date: Mar. 11, 2021

(54) INK DISCHARGE DEVICE, PRINTING DEVICE, AND METHOD FOR CONTROLLING INK DISCHARGE DEVICE

(71) Applicant: KYOCERA Document Solutions Inc., Osaka (JP)

(72) Inventors: Masaaki MARUTA, Osaka (JP); Masato USUI, Osaka (JP)

(73) Assignee: KYOCERA Document Solutions Inc., Osaka (JP)

(21) Appl. No.: 17/044,282

(22) PCT Filed: Mar. 22, 2019
(86) PCT No.: PCT/JP2019/012224

§ 371 Date: Sep. 30, 2020

(30) Foreign Application Priority Data
Apr. 27, 2018 (JP) 2018-087083

(51) Int. Cl. B41J 2/045; B41J 2/15; B41J 3/407; B41J 2/21

(52) U.S. Cl. CPC B41J 2/04581; B41J 2/15; B41J 2/04593; B41J 2/21; B41J 3/4078

(57) ABSTRACT

The head (8) of an ink discharge device (1) discharges ink into a recording medium being conveyed. A movement unit (12) moves the head (8) in the height direction (Z-axis direction) when the printing surface of the recording medium is set as the front surface. A controller (10) sets a discharge time gap, which is the gap between the nozzle (81) and the printing surface during ink discharge, in accordance with the image to be printed and the recording medium. The controller (10) causes the movement unit (12) to move the head in the Z-axis direction so as to reach the set discharge interval.

### TECHNICAL FIELD

The present invention relates to an ink discharge device which performs printing with respect to a recording medium, a printing device which performs printing by using the ink discharge device and a plate, and a method for controlling the ink discharge device.

### BACKGROUND ART

Printing can be performed on a textile material such as a fabric, clothes, etc. In a case where printing is performed with respect to a textile material, ink is applied to the textile material. After being applied to the textile material, the ink is fixed thereto. For printing with respect to a textile material, an inkjet printing machine may be used. An example of the technique for printing with respect to a textile material by using an inkjet printing machine is disclosed in Patent Document 1 identified below.

Specifically, Patent Document 1 discloses a digital printing machine which includes a rigid frame, a first linear motion X-axis stage mounted on the frame, a second linear motion X-axis stage mounted on the frame parallel to the first linear motion X-axis stage and arranged for operation independently of the first linear motion X-axis stage, a printing table assembly movable on each linear motion X-axis stage, a linear motion Y-axis stage mounted on the frame perpendicular to the linear motion X-axis stages, above the printing table assembly, and an array of inkjet nozzles mounted on the linear motion Y-axis stage for linear motion perpendicular to the X-axis stage. This configuration is intended for printing with respect to clothes by moving an inkjet printing machine in a direction perpendicular to the moving direction of the printing table assembly (Patent Document 1: claim 1, paragraphs [0041], [0042]).

### CITATION LIST

### Patent Documents

Patent Document 1: Japanese Translation of PCT International Application Publication No. 2007-525339

### SUMMARY OF THE INVENTION

### Technical Problem

As mentioned above, for printing with respect to a textile material, an inkjet printing machine can be used. An inkjet printing machine sprays ink onto a textile material. For printing with respect to a textile material, using an inkjet printing machine is more advantageous than using a plate, because with an inkjet printing, it is easy to print a detailed image. Further, even for printing an image in many colors, there is no need of preparing a large number of plates. On the other hand, inkjet printing machines have disadvantages as well. For example, an inkjet printing machine prints an image with respect to a textile material by spraying fine ink droplets (liquid droplets) onto the textile material, and thus it tends to be difficult to achieve a desired density with the inkjet printing device. Also, color unevenness may be caused in a certain area where uniform color density is desired.

An inkjet printing machine includes a head. The head incudes a plurality of nozzles. If the inkjet printing machine is of a serial type, the inkjet head is reciprocated in a direction perpendicular to a conveyance direction in which a textile material is conveyed. Printing is performed by discharging ink in association with movement of the textile material. However, this is disadvantageous in that the head is allowed to move only in a fixed moving direction that is perpendicular to the conveyance direction, and thus the moving direction of the head is limited.

Also in the digital printing machine disclosed in Patent Document 1, the inkjet nozzles are moved in a limited moving direction, which is a direction of the linear Y axis stage (a direction perpendicular to the conveyance direction). Furthermore, with the digital printing machine disclosed in Patent Document 1, it can be difficult to achieve a desired density, and also color unevenness can be caused. Accordingly, the technique disclosed in Patent Document 1 is not helpful to solve the problem presented above.

The present invention has been made in view of the above problem, and solves the inconvenience caused by the limited moving direction of a head to thereby achieve high-quality, high-density printing without unevenness with respect to a fabric.

### Solution to Problem

According to an aspect of the present invention, an ink discharge device is attached to a conveyance line which conveys a recording medium by using a conveyance device and which is provided with a plate device which performs printing by using a plate. The ink discharge device may be attachable to and detachable from the conveyance line, or the ink discharge device may be fixed to the conveyance line. The ink discharge device includes a head, a movement unit, and a controller. The head prints an image based on image data by discharging ink from a nozzle to a printing surface of the recording medium conveyed by the conveyance device. The movement unit makes the head move in a Z-axis direction which is a height direction when the printing surface of the recording medium is taken as a front face, and moves the head at least in two axial directions. The controller, in accordance with an image to be printed or the recording medium, sets a discharge-time distance which is a distance between the nozzle and the printing surface during ink discharge, and makes the movement unit move the head in the Z-axis direction to achieve the discharge-time distance set.

### Advantageous Effects of Invention

According to the present invention, it is possible to solve the inconvenience caused by limiting the moving direction of the head. Moreover, high-quality and high-density printing without unevenness can be performed with respect to a fabric.

### BRIEF DESCRIPTION OF THE DRAWINGS

FIG. 1 is a diagram showing an example of a printing device according to an embodiment or an example of a printing device;

FIG. 2 is a diagram showing the example of the printing device according to the embodiment or the example of the printing device;

FIG. 3 is a diagram showing the example of the printing device according to the embodiment or the example of the printing device;

FIG. 4 includes diagrams each showing an example of an installation position of an ink discharge device according to the embodiment;

FIG. 5 is a diagram showing an example of the ink discharge device according to the embodiment;

FIG. 6 is a diagram showing an example of a head according to the embodiment;

FIG. 7 is a diagram showing the example of the head according to the embodiment;

FIG. 8 is a diagram showing an example of a movement unit according to the embodiment;

FIG. 9 is a diagram showing an example of a flow of retracting the head in the printing device according to the embodiment;

FIG. 10 is a diagram showing an example of a flow of wiping the head in the printing device according to the embodiment;

FIG. 11 is a diagram showing an example of a flow of flushing the head according to the embodiment;

FIG. 12 is a diagram showing an example of a flow of feeding printing data according to the embodiment;

FIG. 13 is a diagram showing an example of printing in a stationary-target printing mode according to the embodiment;

FIG. 14 is a diagram showing an example of printing in a conveyed-target printing mode according to the embodiment;

FIG. 15 is a diagram showing an example of movement of the head in each printing mode according to the embodiment;

FIG. 16 is a diagram showing an example of definition data according to the embodiment;

FIG. 17 is a diagram showing an example of an image-type selection screen according to the embodiment;

FIG. 18 is a diagram showing an example of a smoothness-level selection screen according to the embodiment;

FIG. 19 is a diagram showing an example of a flow of movement of the head in a Z-axis direction according to the embodiment;

FIG. 20 is a diagram showing an example of ink discharge amount data according to the embodiment;

FIG. 21 is a diagram showing an example of parts related to shooting an image of a printing surface performed in the printing device according to the embodiment;

FIG. 22 is a diagram showing an example of a flow in an automatic image addition mode according to the embodiment;

FIG. 23 is a diagram showing an example of a flow in a copy mode according to the embodiment;

FIG. 24 is a diagram showing an example of a head according to a modified example;

FIG. 25 is a diagram showing an example of an ink discharge device according to the modified example; and

FIG. 26 is a diagram showing an example of a flow of movement of the head in the Z-axis direction with respect to the printing surface according to the modified example.

### DESCRIPTION OF EMBODIMENTS

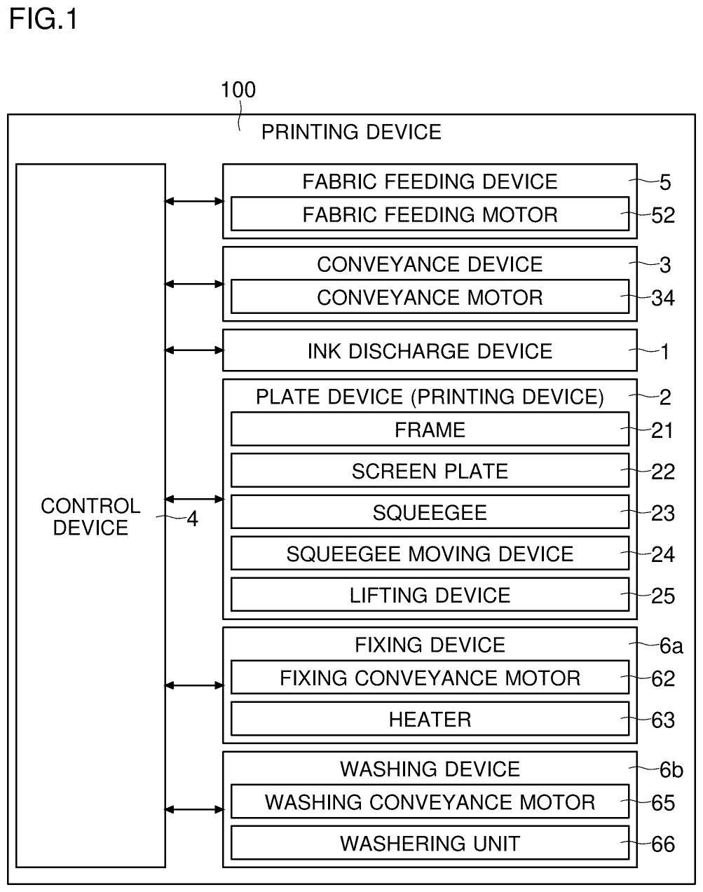

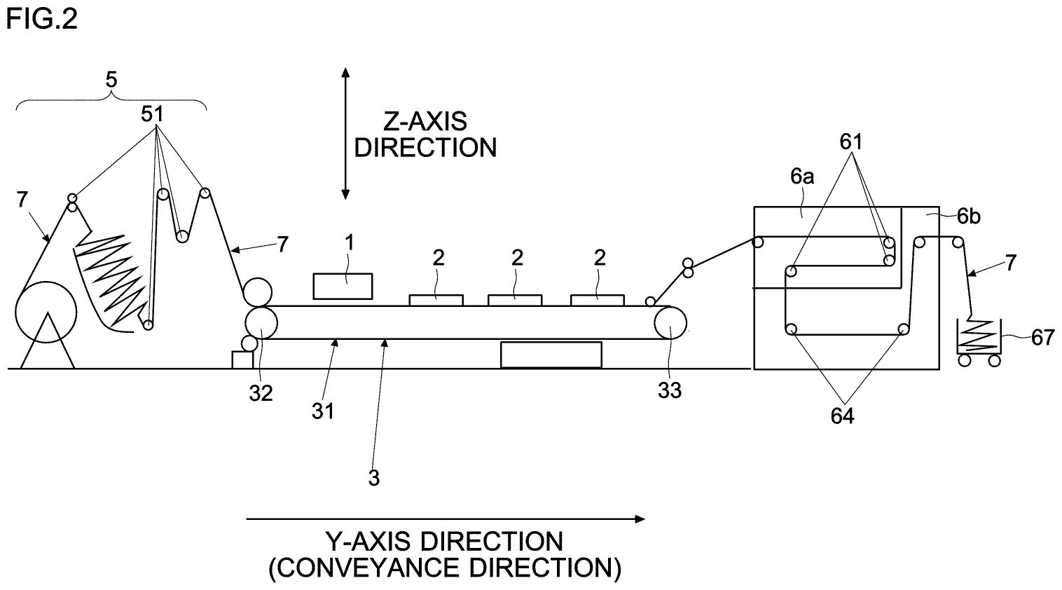

With reference to FIGS. 1 to 26, a description will be given of an example of an ink discharge device 1 and a printing device 100 according to each of an embodiment and a modified example. The ink discharge device 1 and the printing device 100 performs printing with respect to a recording medium. In the following description, a fabric 7 is dealt with as an example of the recording medium. However, the recording medium is not limited to the fabric 7. The recording medium may be a sheet of paper, for example. Further, the recording medium may be any material other than fabric or paper, such as a resin sheet. The recording medium can be of any material usable for printing by both the ink discharge device 1 and a plate device 2. FIGS. 1 to 3 are each a diagram showing an example of the printing device 100 according to the embodiment.

In the following description, a direction perpendicular to a conveyance direction of the recording medium when a printing surface of the recording medium is taken as a front face will be referred to as an X-axis direction. The conveyance direction of the recording medium when the printing surface of the recording medium is taken as the front face will be referred to as a Y-axis direction. A height direction (front-rear direction) when the printing surface of the recording medium is taken as the front face will be referred to as a Z-axis direction.

The printing device 100 performs printing with respect to the fabric 7, for example. The printing device 100 at least includes the ink discharge device 1, the plate device 2, and a conveyance device 3. The printing device 100 is a hybrid printing system capable of performing both printing by using a plate and inkjet printing. The printing device 100 may further include a control device 4, a fabric feeding device 5, a fixing device 6a, and a washing device 6b.

The conveyance device 3 conveys a recording medium (a fabric). The plate device 2 is provided on a conveyance line which is for the recording medium conveyed by the conveyance device 3. The conveyance line is provided with the plate device 2, which performs printing by using a plate. The ink discharge device 1 is attachable to and detachable from this conveyance line. For example, the ink discharge device 1 can be added to the conveyance line and the plate device 2 that have already been installed. Of the conveyance line and plate devices 2 which have already been installed, part of the plate devices 2 may be detached and the ink discharge device 1 may be provided instead. The ink discharge device 1 installed can be detached from the conveyance line. With respect to the plate device 2 and the conveyance line, the ink discharge device 1 is attachable and detachable. Thus, the ink discharge device 1 which performs digital printing can be supplied to the market as a product on its own.

The ink discharge device 1 may be fixed to the conveyance line. The ink discharge device 1 may be non-detachable with respect to the conveyance line, the plate device 2, and the conveyance device 3. In this case, the ink discharge device 1 is sold together with the plate device 2 and the conveyance device 3. The printing device 100 can also be supplied to the market as a package including the ink discharge device 1 which performs digital printing and the plate device 2 which performs analog printing.

The control device 4 controls the ink discharge device 1, the plate device 2, the conveyance device 3, the fabric feeding device 5, the fixing device 6a, and the washing device 6b. The fabric feeding device 5 has set therein the fabric 7 rolled in a cylindrical form. During printing, the fabric feeding device 5 feeds the fabric 7 for printing. The fabric feeding device 5 includes a fabric feeding roller 51 and a fabric feeding motor 52. The fabric feeding roller 51 feeds out the fabric 7. A plurality of fabric feeding rollers 51 may be provided. During printing, the control device 4 makes the fabric feeding motor 52 turn. The fabric feeding motor 52 makes the fabric feeding rollers 51 turn.

The conveyance device 3 includes a conveyance belt 31, a drive roller 32, a driven roller 33, and a conveyance motor 34. The conveyance belt 31 is wound around the drive roller 32 and the driven roller 33. The conveyance motor 34 makes the drive roller 32 turn. In association with the turning of the drive roller 32, the conveyance belt 31 rotates. The conveyance belt 31 and the fabric 7 contact each other. The fabric 7 is stretched on the conveyance belt 31. In association with the rotation of the conveyance belt 31, the fabric 7 is conveyed. During printing, the control device 4 makes the conveyance motor 34 turn. Thereby, the control device 4 makes the conveyance belt 31 rotate.

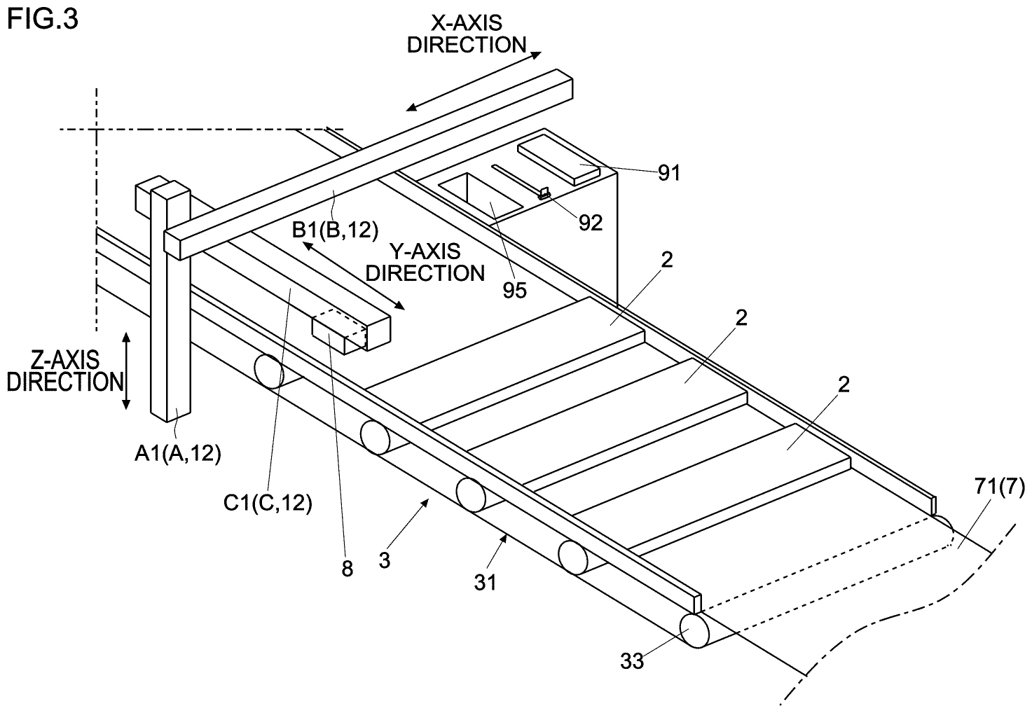

The plate device 2 is a unit that performs printing by using a plate. Below the plate device 2, the fabric 7 passes. For example, the plate device 2 performs screen printing with respect to the fabric 7. An image (design) in one color can be printed with one plate device 2. The same number of plate devices 2 as the number of colors to be used in printing need to be prepared. As shown in FIG. 3, the number of the plate device 2 is not limited to one. A plurality of plate devices 2 can be provided.

The plate devices 2 each include a frame 21, a screen plate 22, a squeegee 23, a squeegee moving device 24, and a lifting device 25. The lifting device 25 lifts and lowers the frame 21. The screen plate 22 is provided within the frame 21. To the frame 21, the squeegee 23 and the squeegee moving device 24 are attached. The screen plate 22 is made of fiber, resin, or metal, for example. Of the screen plate 22, part from which ink is applied to the fabric 7 is so formed, by engraving or the like, as to pass ink therethrough. The squeegee 23 is formed in a spatula shape, and located above the screen plate 22. A lower end part (a spatula part) of the squeegee 23 contacts the screen plate 22.

A color paste is placed on the screen plate 22. A color paste of one color is placed in each frame 21. On each plate device 2, there is placed a color paste of a color in which printing is to be performed with respect to the fabric 7 by using the screen plate 22. The moving device reciprocates the squeegee 23 within the frame 21. The direction of the movement is a longitudinal direction of the frame 21 (a perpendicular direction with respect to the Y-axis direction, the X-axis direction). While reciprocating, the squeegee 23 rubs against an upper surface of the screen plate 22. The squeegee moving device 24 includes, for example, a motor. By the reciprocation of the squeegee 23, the color paste is pushed out through an ink passing part of the screen plate 22. The color paste is pushed out onto the fabric 7. In this manner, printing with respect to the fabric 7 is performed. In the printing device 100, the plate device 2 can be used for solid printing.

In the case of printing by using the plate device 2, the control device 4 makes the conveyance device 3 repeat conveyance of the fabric 7 and suspension of the conveyance. The control device 4 suspends the conveyance of the fabric 7 each time the fabric 7 is conveyed in the Y-axis direction by a prescribed distance F1. During the suspension of the conveyance, the control device 4 makes the lifting device 25 lower the frame 21 and the screen plate 22 until they come into contact with the fabric 7. Then, the control device 4 makes the moving device reciprocate the squeegee 23. In this manner, printing is performed with respect to the fabric 7. After the printing with respect to the fabric 7, the control device 4 lifts the frame 21 and the screen plate 22 until they come out of contact with the fabric 7. After completing the lifting of the frame 21 and the screen plate 22, the control device 4 restarts to convey the fabric 7 by the prescribed distance F1. Thus, by repeating the series of process (suspending the conveyance, lowering the frame 21 and so on, reciprocating the squeegee 23, lifting the frame 21 and so on, restarting the conveyance), printing by using the plate with respect to the fabric 7 is repeated.

The prescribed distance F1 is, for example, equal to a length of the screen plate 22 in the Y-axis direction. In other words, the prescribed distance F1 can be a length in the Y-axis direction over which printing can be performed by using the screen plate 22. In a case where a plurality of plate devices 2 are provided, the prescribed distance F1 can be equal to a distance between an upstream-side one of the plate devices 2 and a downstream-side one of the plate devices 2. In this manner, printing without a gap can be performed with respect to the fabric 7.

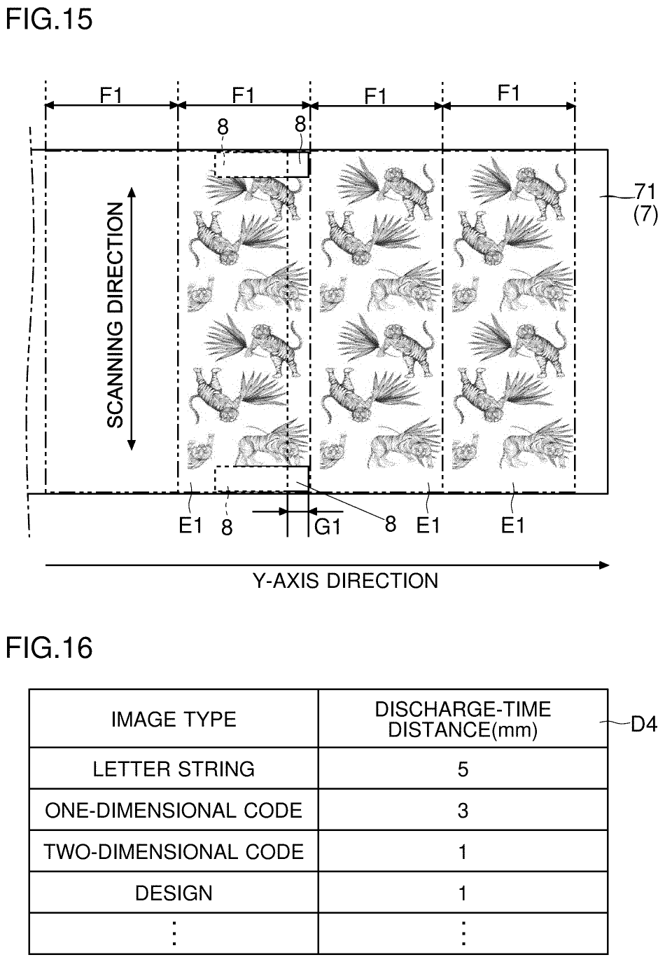

In the fabric 7, a rectangle-shaped region having a length, in the Y-axis direction, equal to the prescribed distance F1 is one printing unit. Hereinafter, this printing unit will be referred to as a unit printing range E1 (see FIG. 15). The length of the unit printing range E1 in the Y-axis direction is equal to the prescribed distance F1. A length of the unit printing range E1 in the perpendicular direction (the X-axis direction) is equal to a width of the fabric 7 in the perpendicular direction.

It should be noted that the plate device 2 is not limited to one that uses the frame 21. The plate device 2 may be of a rotary screen printing type that performs printing by using a cylindrical tube. Or, the plate device 2 may be of a roller printing type that performs printing (fabric printing) by applying color paste to a recess of a intaglio copper roller.

The ink discharge device 1 performs printing by using ink with respect to the fabric 7 conveyed. The ink discharge device 1 includes a head 8 which discharges ink. The ink discharge device 1 is a type of inkjet printer. Conventionally, in a case where a serial printing head is used, the moving direction of the printing head is limited to one direction (the perpendicular direction). During printing with respect to the fabric 7 with such a printing head, the printing head is reciprocated while the fabric 7 is conveyed. On the other hand, the ink discharge device 1 can move the head 8 three-dimensionally (details of which will be given later). Thus, the ink discharge device 1 can perform printing with respect to the fabric 7 both in a stationary state and under conveyance. During printing, the control device 4 makes the ink discharge device 1 perform printing with respect to the fabric 7.

A printing range of the ink discharge device 1 in one event of printing is the unit printing range E1. The printing range is of the same range (area) as the printing range of the screen plate 22. The fabric 7 is fed in a continuous manner, and thus the ink discharge device 1 repeatedly performs printing in unit printing ranges E1. The ink discharge device 1, for example, discharges ink to a part with respect to which printing is not performed by the plate device 2. For example, on the fabric 7, printing of a design in a plurality of colors, a design including gradation, and the like can be performed by using the ink discharge device 1.

The fabric 7, after passing the conveyance belt 31, is conveyed into the fixing device 6a. The fixing device 6a includes, for example, a fixing conveyance roller 61, a fixing conveyance motor 62, and a heater 63. During printing, the control device 4 makes the fixing conveyance motor 62 turn in association with the conveyance of the fabric 7 performed by the conveyance device. In this manner, the control device 4 has the fabric 7 conveyed within the fixing device 6a. Also, during printing, the control device 4 supplies power to the heater 63. With heat from the heater 63, ink is fixed on the fabric 7.

After the fixing, the fabric 7 is conveyed into the washing device 6b. The washing device 6b includes, for example, a washing conveyance roller 64, a washing conveyance motor 65, and a washing unit 66. During printing, the control device 4 makes the washing conveyance motor 65 turn in association with the conveyance of the fabric 7 by the conveyance device 3 and by the fixing device 6a. In this manner, the control device 4 has the fabric 7 conveyed inside the washing device 6b. During printing, the control device 4 makes the washing device 6b perform washing of the fabric 7. The washing device 6b sprays water to the fabric 7. The washing device 6b washes away excess (unfixed) ink and the color paste. After being washed, the fabric 7 is ejected outside the washing device 6b. The fabric 7 ejected is received in a receiving container 67.

(Installation Position of Ink Discharge Device 1)

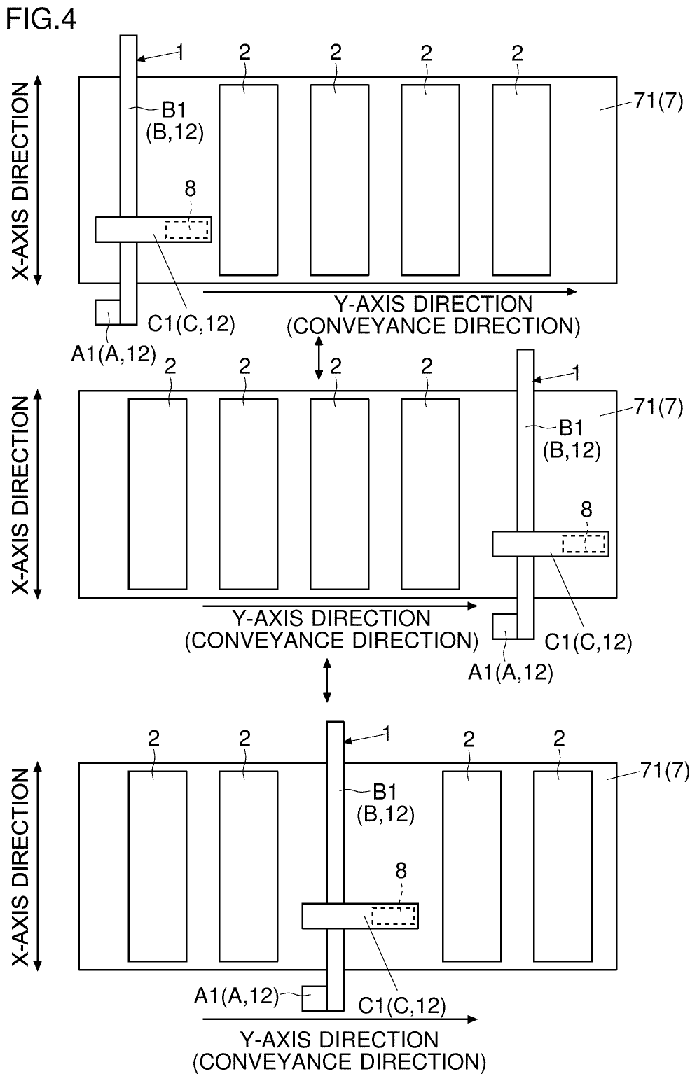

Next, with reference to FIG. 4, a description will be given of an example of the installation position of the ink discharge device 1 according to the embodiment. FIG. 4 includes diagrams each showing an example of the installation position of the ink discharge device 1 according to the embodiment.

FIG. 4 schematically illustrates the conveyance line (the conveyance device 3, the conveyance belt 31, the plate devices 2) as seen from above. The ink discharge device 1 and the plate devices 2 are provided above the conveyance belt 31. As shown in a top diagram of FIG. 4, the ink discharge device 1 may be provided on an upstream side of all the plate devices 2 in the Y-axis direction. Or, as shown in a middle diagram of FIG. 4, the ink discharge device 1 may be provided on a downstream side of all the plate devices 2 in the Y-axis direction. Or, as shown in a bottom diagram of FIG. 4, the ink discharge device 1 may be provided between a plurality of plate devices 2 in the Y-axis direction.

Just by adding the ink discharge device 1 to an existing screen-printing system, it is possible to achieve he printing device 100 which is equipped with the advantages of both the plate device 2 and the ink discharge device 1. There is no particular limitation to where to install the ink discharge device 1. Thus, the printing device 100 can be installed without major modification of existing printing equipment.

(Ink Discharge Device 1)

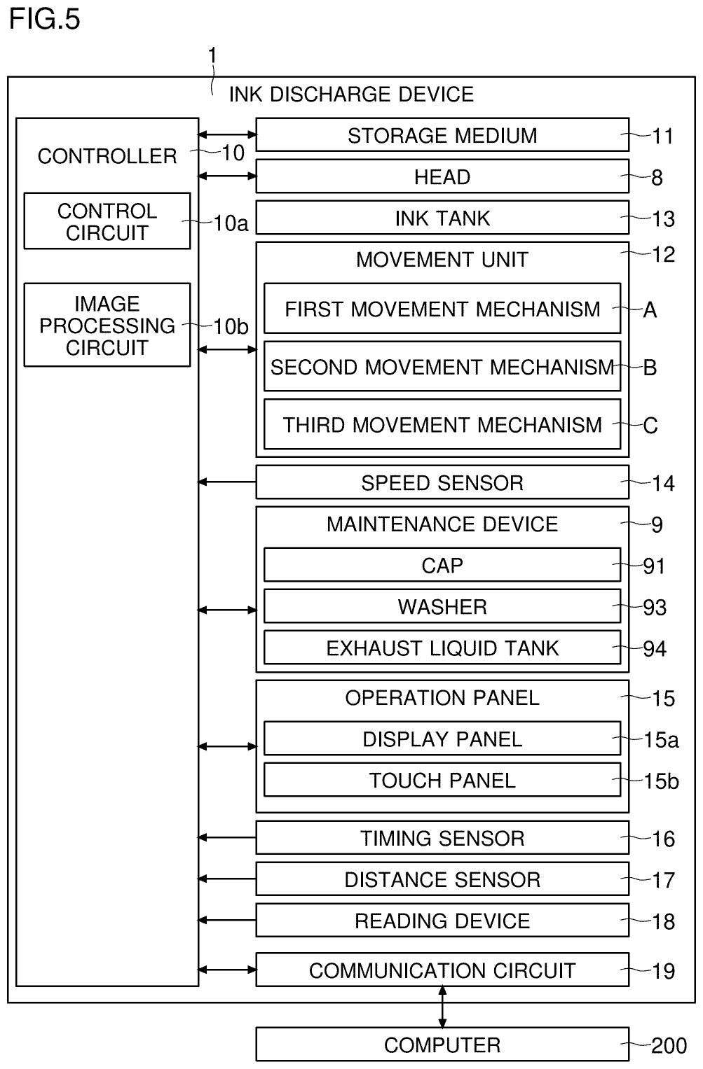

Next, with reference to FIG. 5, a description will be given of an example of the ink discharge device 1 according to the embodiment. FIG. 5 is a diagram showing the example of the ink discharge device 1 according to the embodiment.

The ink discharge device 1 includes a controller 10. The controller 10 controls an operation of the ink discharge device 1. The controller 10 is a circuit board. The controller 10 includes a control circuit 10a and an image processing circuit 10b. The control circuit 10a is, for example, a CPU. The image processing circuit 10b is, for example, an ASIC for image processing. The image processing circuit 10b performs image processing with respect to image data D2 used for printing. The control circuit 10a performs processing based on a control program and control data stored in a storage medium 11. The storage medium 11 includes a non-volatile storage device, such as a ROM an HDD, and a flash ROM. The storage medium 11 also includes a volatile storage device, such as a RAM.

The ink discharge device 1 includes the head 8. The head 8 includes nozzles 81 arranged in an array. The head 8 discharges ink of a plurality of colors. With the head 8, color printing can be performed. For example, the head 8 discharges black ink, yellow ink, cyan ink, and magenta ink. The ink discharge device 1 includes a plurality of ink tanks 13. The ink tanks 13 are provided one for each of the plurality of colors. For the sake of convenience, FIG. 5 illustrates just one of the ink tanks 13. The ink tanks 13 are each filled with ink. From each of the ink tanks 13, ink of a corresponding color is supplied to the head 8. Ink is supplied to the head 8 by making use of hydraulic head difference.

The controller 10 makes the head 8 perform printing of an image. The controller 10, based on the image data D2, makes the nozzles 81 of the head 8 discharge ink to a printing surface 71 of the fabric 7. The ink discharge device 1 further includes a movement unit 12. The movement unit 12 moves the head 8 at least in two axial directions. Specifically, the movement unit 12 makes the head 8 move in three axial directions. The movement unit 12 includes a first movement mechanism A, a second movement mechanism B, and a third movement mechanism C. The first movement mechanism A moves the head 8 in the Z-axis direction with respect to the printing surface 71 (the fabric 7, the conveyance belt 31). The second movement mechanism B moves the head 8 in the X-axis direction. The third movement mechanism C moves the head 8 in the Y-axis direction. The Z-axis direction is a front-rear direction when the printing surface 71 is taken as the front face. The head 8 is attached to the movement unit 12 such that a nozzle array 80 of each color is arranged in the Y-axis direction (parallel to the Y-axis direction). The controller 10 controls the movement unit 12. That is, the controller 10 controls a position of the head 8.

A speed sensor 14 is a sensor for detecting a conveyance speed (a speed of movement in the Y-axis direction) of the fabric 7. For example, the speed sensor 14 irradiates the fabric 7 with laser light, microwaves, ultrasonic waves, or the like. The speed sensor 14 measures the speed based on a frequency variation of waves reflected from the fabric 7. The speed sensor 14 feeds the controller 10 with a signal indicating the measured speed. The controller 10, based on the output of the speed sensor 14, recognizes the conveyance speed of the fabric 7. In a case where printing is performed only with respect to the fabric 7 in the stationary state, the speed sensor 14 does not need to be provided.

The ink discharge device 1 includes a maintenance device 9. The maintenance device 9 is a device for preventing and clearing clogging of the nozzles 81. The maintenance device 9 includes a cap 91. The cap 91 is put on the head 8. For the purpose of preventing ink from drying up, the controller 10 makes the movement unit 12 move the head to a position of the cap 91. The cap 91 is a member made of a sheet metal coated with rubber. For example, the cap 91 has a shape having a recess. In the recess, an end part of the head 8 on a side of an exposure face (a lower end part) is fitted. The exposure face is a face of the head 8 at which the nozzles 81 are exposed. The cap 91 seals the exposure face at which the nozzles 81 are exposed. The cap 91 prevents evaporation of ink from the nozzles 81.

The maintenance device 9 includes a cleaning member 92 and a washer 93. The cleaning member 92 is plate-shaped (a blade). The cleaning member 92 is movable in the Y-axis direction. The cleaning member 92 is made of rubber, for example. During wiping, an edge of the blade is in contact with the nozzles 81. The controller 10, to wipe the nozzles 81, makes the movement unit 12 move the head 8. The controller 10 makes the head 8 move such that ends of the nozzles 81 are rubbed by the blade. The controller 10 may make the cleaning member 92 move with the head 8 fixed at a position such that the nozzles 81 and the blade are in contact with each other. In this manner, the cleaning member 92 scrapes off foreign particles, dust, and viscous ink.

The washer 93 pours (sprays) a washing solution to the cleaning member 92 before the cleaning member 92 rubs the nozzles 81. This helps reduce friction of the cleaning member 92, and thus no damage is caused to the nozzles 81 by the cleaning member 92 when it rubs the nozzles 81. The washer 93 washes the cleaning member 92 with the washing solution after the wiping. The washer 93 washes ink off the cleaning member 92. The maintenance device 9 includes an exhaust liquid tank 94. The washing solution and ink having been washed away with the washing solution flow into the exhaust liquid tank 94.

The maintenance device 9 includes an opening 95 (see FIG. 3). The opening 95 is larger in area than the exposure face of the head 8. The opening 95 leads to the exhaust liquid tank 94. The controller 10, to throw away ink, makes the movement unit 12 move the head 8 to a position over the opening 95. The ink thrown away into the opening 95 flows into the exhaust liquid tank 94.

The ink discharge device 1 includes an operation panel 15. The operation panel 15 includes a display panel 15a and a touch panel 15b. The display panel 15a displays setting screens and information. The display panel 15a displays operation images such as images of a key, a button, and a tab. The touch panel 15b senses a touch operation performed with respect to the display panel 15a. Based on an output of the touch panel 15b, the controller 10 recognizes an operated operation image. The controller 10 recognizes a setting operation performed by a user.

The ink discharge device 1 further includes a timing sensor 16. The timing sensor 16 is a sensor for determining a time point to start printing. The timing sensor 16 detects that a leading end part of the fabric 7 on a downstream side in the conveyance direction (the Y-axis direction) has reached a predetermined point. The controller 10 determines the timing to start printing based on the detection of the reaching of the leading end part by the timing sensor 16.

A communication circuit 19 communicates with a computer 200. The computer 200 is a PC or a server, for example. The communication circuit 19 receives printing data D1 from the computer 200. The controller 10 moves the head 8 based on the printing data D1. The controller 10 makes the head 8 discharge ink based on the printing data D1.

(Head 8)

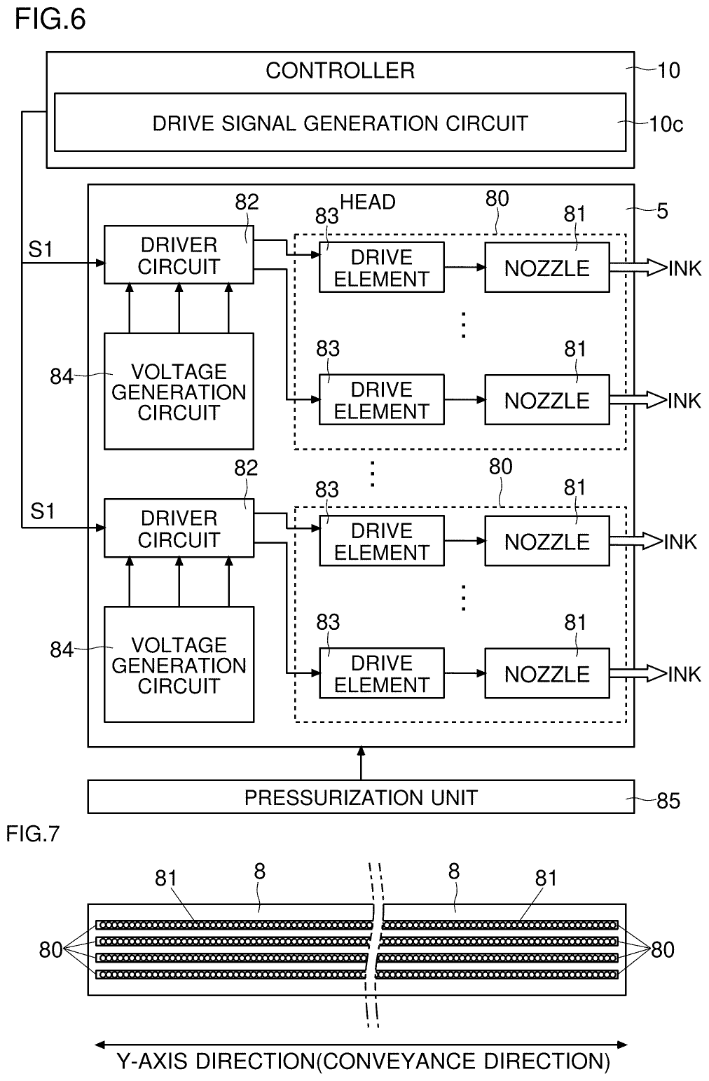

Next, with reference to FIG. 6 and FIG. 7, a description will be given of the head 8 according to the embodiment. FIG. 6 and FIG. 7 are diagrams showing an example of the head 8 according to the embodiment.

The head 8 performs printing with respect to the fabric 7. The head 8 sprays ink onto the printing surface 71 of the fabric 7. The head 8 includes a plurality of nozzle arrays 80. The nozzle arrays 80 each include a plurality of nozzles 81 arranged in an array. Each nozzle array 80 includes a same number of nozzles 81. The nozzle arrays 80 are provided one for each color of ink. Different nozzle arrays 80 discharge ink of different colors (black, yellow, cyan, and magenta). Each nozzle array 80 is parallel to the Y-axis direction of the fabric 7. That is, the nozzles 81 included in the nozzle arrays 80 are arranged along the Y-axis direction (see FIG. 7).

The nozzles 81 are formed to be equally spaced from each other in the Y-axis direction. Ink is discharged through an opening of each nozzle 81. A length from an upstream-side end nozzle 81 to a downstream-side end nozzle 81 in the Y-axis direction (the conveyance direction) is an image forming range in which an image is formed in one event of ink discharge. As shown in FIG. 6, drive elements 83 are provided one for each nozzle 81. The drive element 83 is a piezoelectric element. The drive element 83 is a piezo element, for example.

As shown in FIG. 6, the head 8 includes a plurality of driver circuits 82. The driver circuits 82 perform turning ON/OFF of voltage application to the drive elements 83. The controller 10 feeds each driver circuit 82 with the image data D2 (data indicating a nozzle 81 that is to discharge ink) for each line. The driver circuits 82 each apply a pulse voltage to the drive element 83 of the nozzle 81 that is to discharge ink. The drive element 83 is deformed by the voltage application. The pressure resulting from the deformation of the drive element 83 is applied to a flow path (not shown) for supplying ink to the nozzle 81. The pressure applied to the flow path causes ink to be discharged from the nozzle 81. On the other hand, the driver circuit 82 does not apply a voltage to the drive element 83 corresponding to a nozzle 81 that is not to discharge ink. The driver circuits 82 actually control ink discharge.

The head 8 further includes voltage generation circuits 84 which each generate a plurality of types of voltages of different magnitudes. The driver circuit 82 applies a voltage generated by the voltage generation circuit 84 to the drive element 83. As a larger voltage is applied, the drive element 83 is deformed more. As a result, a larger amount of ink droplets are discharged. As a smaller voltage is applied, the drive element 83 is deformed less. As a result, a smaller amount of ink droplets are discharged. The driver circuits 82 can adjust the amount of ink droplets to be discharged.

The controller 10 further includes a drive signal generation circuit 10c. The drive signal generation circuit 10c generates a drive signal S1. The drive signal S1 is a signal for driving the head 8. The drive signal generation circuit 10c generates a clock signal, for example. The head 8 (the driver circuits 82) discharges ink each time the drive signal S1 rises. A reference cycle of ink discharge is determined in advance. The controller 10 makes the drive signal generation circuit 10c generate the drive signal S1 of a frequency such that ink is discharged at the reference cycle.

(Movement Unit 12)

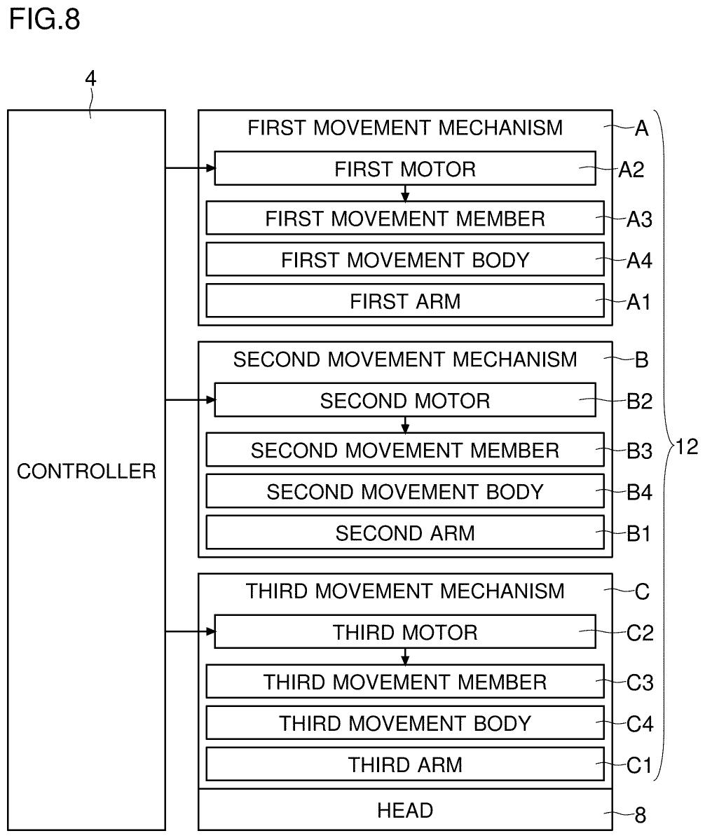

Next, with reference to FIG. 3 and FIG. 8, a description will be given of the movement unit 12 according to the embodiment. FIG. 8 shows an example of the movement unit 12 according to the embodiment.

The first movement mechanism A moves the head 8 in the Z-axis direction. As shown in FIG. 3, the first movement mechanism A includes a first arm A1. The first arm A1 is a member having a quadrangular prism shape. The first arm A1 has a first motor A2, a first movement member A3, and a first movement body A4 built therein. The first motor A2 is a stepping motor, for example. The first motor A2 can turn in forward and reverse directions. The controller 10 controls the turning of the first motor A2. The first motor A2 makes the first movement member A3 turn. The first movement member A3 is a ball screw, for example. The first movement body A4 is integrated with a nut attached to the ball screw. The first motor A2 makes the first movement member A3 turn. Thereby, the turning motion of the first motor A2 is converted into a linear motion. As a result, the first movement body A4 moves in the Z-axis direction. The first arm A1 guides the movement of the first movement body A4.

The second movement mechanism B moves the head 8 in the X-axis direction. As shown in FIG. 3, the second movement mechanism B includes a second arm B1. The second arm B1 is a member having a quadrangular prism shape. The second arm B1 has a second motor B2, a second movement member B3, and a second movement body B4 built therein. The second motor B2 is a stepping motor, for example. The second motor B2 can turn in forward and reverse directions. The controller 10 controls the turning of the second motor B2. The second motor B2 makes the second movement member B3 turn. The second movement member B3 is a ball screw, for example. The second movement body B4 is integrated with a nut attached to the ball screw. The second motor B2 makes the second movement member B3 turn. Thereby, the turning motion of the second motor B2 is converted into a linear motion. As a result, the second movement body B4 moves. The second arm B1 guides the movement of the second movement body B4.

The third movement mechanism C moves the head 8 in the Y-axis direction. As shown in FIG. 3, the third movement mechanism C includes a third arm C1. The third arm C1 is a member having a quadrangular prism shape. The third arm C1 has a third motor C2, a third movement member C3, and a third movement body C4 built therein. The third motor C2 is a stepping motor, for example. The third motor C2 can turn in forward and reverse directions. The controller 10 controls the turning of the third motor C2. The third motor C2 makes the third movement member C3 turn. The third movement member C3 is a ball screw, for example. The third movement body C4 is integrated with a nut attached to the ball screw. The third motor C2 makes the third movement member C3 turn. Thereby, the turning motion of the third motor C2 is converted into a linear motion. As a result, the third movement body C4 moves. The third arm C1 guides the movement of the third movement body C4.

The first movement body A4 is connected to part of the second movement mechanism B. For example, an end part of the second arm B1 and the first movement body A4 are connected to each other. The head 8 moves in the Z-axis direction in association with the movement of the first movement body A4. The head 8 can be moved both close to and away from the fabric 7. By making the first motor A2 turn, the controller 10 can change a height (position in the Z-axis direction) of the head 8 (the nozzles 81).

The second movement body B4 is connected to part of the third movement mechanism C. For example, part of the third arm C1 and the second movement body B4 are connected to each other. The head 8 moves in the X-axis direction (the perpendicular direction) in association with the movement of the second movement body B4. The position of the head 8 in the X-axis direction with respect to the fabric 7 is changeable. By making the second motor B2 turn, the controller 10 can change, in the X-axis direction, an ink discharge position (a printing position) at which ink is discharged from the head 8 (the nozzles 81).

The head 8 is attached to the third movement body C4 such that the nozzle arrays 80 are parallel to the Y-axis direction (the conveyance direction). In association with the movement of the third movement body C4, the head 8 moves in the Y-axis direction of the fabric 7. The position of the head 8 in the Y-axis direction with respect to the fabric 7 is changeable. By making the third motor C2 turn, the controller 10 can change, in the Y-axis direction, the ink discharge position (the printing position) at which ink is discharged from the head 8 (the nozzles 81).

(Retraction of Head 8)

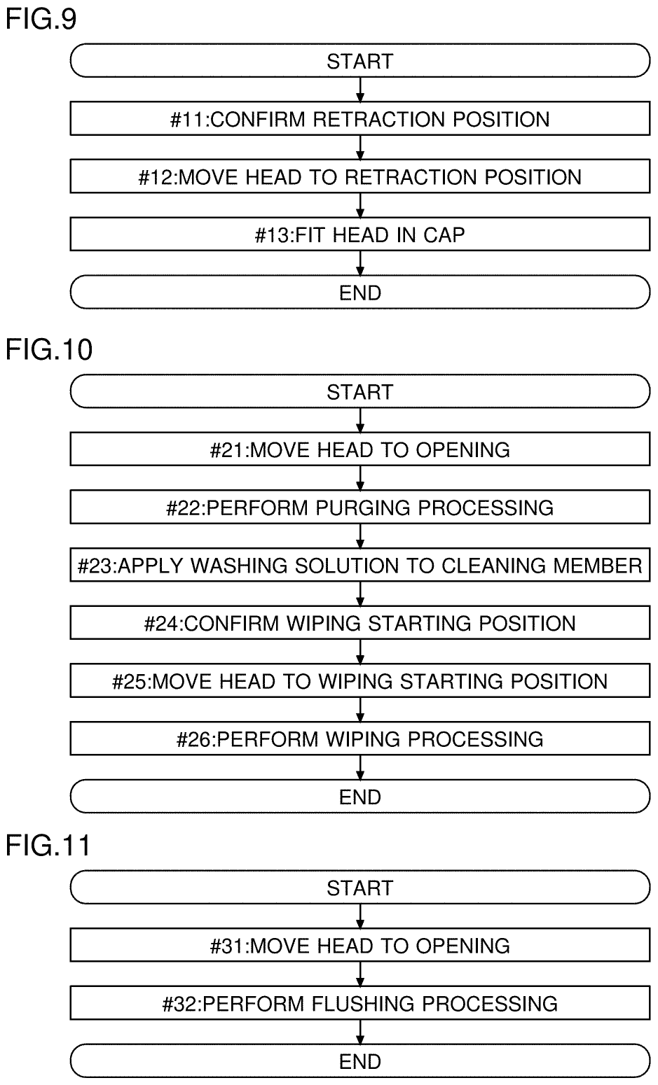

Next, with reference to FIG. 3 and FIG. 9, a description will be given of an example of retraction of the head 8 in the printing device 100 according to the embodiment. FIG. 9 is a diagram showing an example of the flow of retracting the head 8 in the printing device 100 according to the embodiment.

With the nozzle 81 exposed, a volatile component of ink in the nozzles 81 evaporates. As the evaporation proceeds, viscosity of the ink increases. As drying of the ink proceeds, components of the ink become hardened. Such drying of ink may cause clogging of the nozzles 81. For example, if the nozzles 81 are left exposed, clogging occurs. When a nozzle 81 is clogged, the nozzle 81 cannot discharge ink even when voltage is applied to the drive element 83. To maintain high image quality, it is necessary to prevent clogging.

The maintenance device 9 is provided at a position that is within the moving range of the head 8 but outside an upper surface of the fabric 7 (outside the conveyance line) (see FIG. 3). The maintenance device 9 includes the cap 91. The cap 91 is put on the exposure face of the head 8 at which the nozzles 81 are exposed. With the cap 91 put on the exposure face, the drying of ink does not proceed. Longitudinal directions of the head 8 and the cap 91 are parallel to the Y-axis direction. The cap 91 is provided at a position that is outside the fabric 7 (the conveyance line) in the X-axis direction. In other words, the maintenance device 9 is provided at a position that is outside the range in which the head 8 discharges ink to the fabric. Note that there is no particular limitation to the installation position of the cap 91. The cap 91 can be provided anywhere as long as it does not interfere with printing.

FIG. 9 shows an example of the flow of retraction of the head 8 to the cap 91. “START” in FIG. 9 is a time point at which a retraction condition is satisfied. The controller 10 judges whether or not the retraction condition is satisfied. The retraction condition is determined in advance. For example, when the operation panel 15 has accepted an instruction to retract the head 8, the controller 10 judges that the retraction condition has been satisfied. That is, the retraction condition may be the user's having operated the operation panel 15 to input the instruction to retract the head 8. For example, when printing is expected to be stopped for a long time due to a failure of the conveyance line, the user inputs the retraction instruction via the operation panel 15.

The controller 10 may judge that the retraction condition has been satisfied when a predetermined retraction time has come. The retraction time can be a time at which printing with respect to the fabric 7 is stopped. For example, the retraction time may be a lunch-break starting time. The retraction time may be a work-end time. The operation panel 15 accepts a setting of the retraction time. The storage medium 11 stores therein the set retraction time. The controller 10 may judge that the retraction condition has been satisfied when printing has been completed with respect to one roll of the fabric 7 (unit of the fabric 7 to be processed on the conveyance line).

The controller 10 confirms a retraction position (step #11). The storage medium 11 stores therein coordinates of the retraction position in the three axial directions. The controller 10 confirms the coordinates of the retraction position stored in the storage medium 11. The controller 10 makes the movement unit 12 move the head 8 to the retraction position (step #12). In this manner, fitting of the head 8 to the cap 91 is performed (step #13). The head 8 is kept in a state in which ink is prevented from drying. Then, the present flow ends (END). Here, when starting to perform printing, the controller 10 makes the movement unit 12 move the head 8 from the retraction position to the printing position. To start printing, the retraction of the head 8 is cancelled.

(Wiping of Head 8)

Next, with reference to FIG. 3 and FIG. 10, a description will be given of an example of a flow of wiping of the head 8 in the printing device 100 according to the embodiment. FIG. 10 is a diagram showing an example of the flow of the wiping of the head 8 in the printing device 100 according to the embodiment.

The viscosity of ink may increase in some of the nozzles 81 through usage. The viscosity of ink is more likely to increase in a nozzle 81 that has discharged ink less frequently. Through usage, dust, fine particles floating in the air, etc., may adhere to the nozzles 81. These factors can cause clogging. To clear and prevent such clogging, the printing device 100 has a wiping function of wiping the head 8 (the nozzles 81).

The printing device 100 includes the cleaning member 92. FIG. 3 shows an example in which the cleaning member 92 is provided at a position that is in a direction perpendicular to the Y-axis direction of the fabric 7 but outside the fabric 7. The cleaning member 92 is provided beside the cap 91. The direction in which the nozzles 81 are arranged is a direction parallel to the Y-axis direction. Thus, the cleaning member 92 (a blade) is placed such that the blade of the cleaning member 92 extends in a direction (the X-axis direction) perpendicular to the Y-axis direction. Here, the blade may extend in a direction inclined with respect to the perpendicular direction. Note that there is no particular limitation to the installation position of the cleaning member 92. The cleaning member 92 can be provided anywhere as long as it does not interfere with printing.

FIG. 10 shows an example of the flow of the wiping of the head 8. “START” in FIG. 10 is a time point at which a predetermined wiping condition is satisfied. The controller 10 judges whether or not the wiping condition has been satisfied. The wiping condition is determined in advance. For example, when the operation panel 15 has accepted an instruction to wipe the nozzles 81, the controller 10 judges that the wiping condition has been satisfied. That is, the wiping condition may be the user's having operated the operation panel 15 to input the instruction to wipe the head 8.

The controller 10 may judge that the wiping condition has been satisfied when a predetermined wiping time has come. For example, the wiping time may be the lunch-break starting time. The wiping time may be the work-end time. The operation panel 15 accepts a setting of the wiping time. The storage medium 11 stores therein the set wiping time. The controller 10 may judge that the wiping condition has been satisfied when printing is completed with respect to one roll of the fabric 7 (unit of conveyance of the fabric 7).

At a lapse of a predetermined time after the cap 91 is moved away from the head 8, or after the previous wiping, the controller 10 may judge that the wiping condition has been satisfied. In this manner, the head 8 can be wiped before the viscosity of the ink increases. The head 8 may be wiped without fail before each retraction of the head 8 to the retraction position. In this case, when the retraction condition is satisfied, the controller 10 judges that the wiping condition is also satisfied. Then, before putting the cap 91 on the head 8, the controller 10 has the head 8 wiped.

When the wiping condition has been satisfied (START), the controller 10 moves the head 8 to a position over the opening 95 (step #21). Then, the controller 10 has purging processing performed (step #22). The purging processing is processing of making the nozzles 81 discharge (exude) ink. A pressurization unit 85 is provided to apply pressure to the flow path of ink. The pressurization unit 85 is, for example, a pump. The pump is provided on the path for supplying ink from the ink tanks 13 to the head 8. The controller 10 makes the pump operate during the purging processing. The pump applies pressure to the flow path of ink within the head 8. With the pressure, it is possible to remove a cause of clogging (dust, highly viscous ink, etc.) from the nozzles 81. Next, the controller 10 makes the washer 93 apply the washing solution to the cleaning member 92 (step #23). The controller 10 makes a surface of the cleaning member 92 slippery.

Next, the controller 10 confirms a wiping starting position (step #24). The wiping starting position is a position of the head 8 at which the head 8 and the edge of the blade of the cleaning member 92 contact each other. The storage medium 11 stores therein coordinates of the wiping starting position in the three axial directions. The controller 10 confirms the coordinates of the wipe starting position stored in the storage medium 11. Then, the controller 10 makes the movement unit 12 move the head 8 toward the wiping starting position (step #25).

Subsequently, the controller 10 makes the movement unit 12 perform wiping processing (step #26). During the wiping processing, the controller 10 makes the movement unit 12 move the head 8. Specifically, the controller 10 has the head 8 reciprocated in the Y-axis direction, with the cleaning member 92 (the blade) and the nozzles 81 in contact with each other. The controller 10 has the head 8 moved such that all the nozzles 81 come into contact with the cleaning member 92 once or more than once. In this manner, the nozzles 81 are rubbed by the cleaning member 92. The cleaning member 92 scrapes dirt or excess ink off the nozzles 81. Then, the present flow ends (END). Here, during the wiping processing, the controller 10 may have the cleaning member 92 moved with the head 8 in the stationary state.

When restarting printing after the wiping of the head 8, the controller 10 makes the movement unit 12 move the head 8 toward the printing position. When putting the cap 91 on the head 8 after the wiping of the head 8, the controller 10 makes the movement unit 12 move the head 8 toward the retraction position.

(Flushing)

Next, with reference to FIG. 3 and FIG. 11, a description will be given of an example of a flow of flushing of the head 8 in the printing device 100 according to the embodiment. FIG. 11 is a diagram showing an example of the flow of flushing of the head 8 in the printing device 100 according to the embodiment.

To prevent clogging of the nozzles 81, it is preferable to maintain low viscosity of ink in the nozzles 81. It is also preferable to blow away adhered dust and fine particles as soon as possible. For this purpose, the ink discharge device 1 has a function of flushing the head 8 (the nozzles 81).

FIG. 11 shows an example of a flow of flushing of the head 8. “START” in FIG. 11 is a time point at which a predetermined flushing condition is satisfied. The controller 10 judges whether or not the flushing condition has been satisfied. The flushing condition is determined in advance. For example, the controller 10 may judge that the flushing condition has been satisfied when conveyance of the fabric 7 has been temporarily suspended after the fabric 7 is conveyed in the Y-axis direction (the conveyance direction) by the prescribed distance F1. The controller 10 may judge that the flushing condition has been satisfied when printing is completed with respect to a unit printing range E1 (a range of the prescribed distance F1). The controller 10 may judge that the flushing condition has been satisfied at a lapse of a predetermined time after a start of printing or after the previous flushing.

When the flushing condition has been satisfied (START), the controller 10 confirms a flushing starting position (step #31). The flushing starting position is a position at which all the nozzles 81 of the head 8 face the opening 95. In other words, the flushing starting position is a position at which the entire head 8 is located over the opening 95. The controller 10 has the head 8 moved to a position over the opening 95 (step #31). Then, the controller 10 has flushing processing performed (step #32). The flushing processing is processing of making all the nozzles 81 discharge ink toward the opening 95. The controller 10, for example, makes all the nozzles 81 discharge several droplets of ink. Then, the present flow ends (END). When restarting printing after the flushing processing, the controller 10 makes the movement unit 12 move the head 8 toward the printing position. When putting the cap 91 on the head 8, the controller makes the movement unit 12 move the head 8 toward the retraction position.

(Printing Data D1)

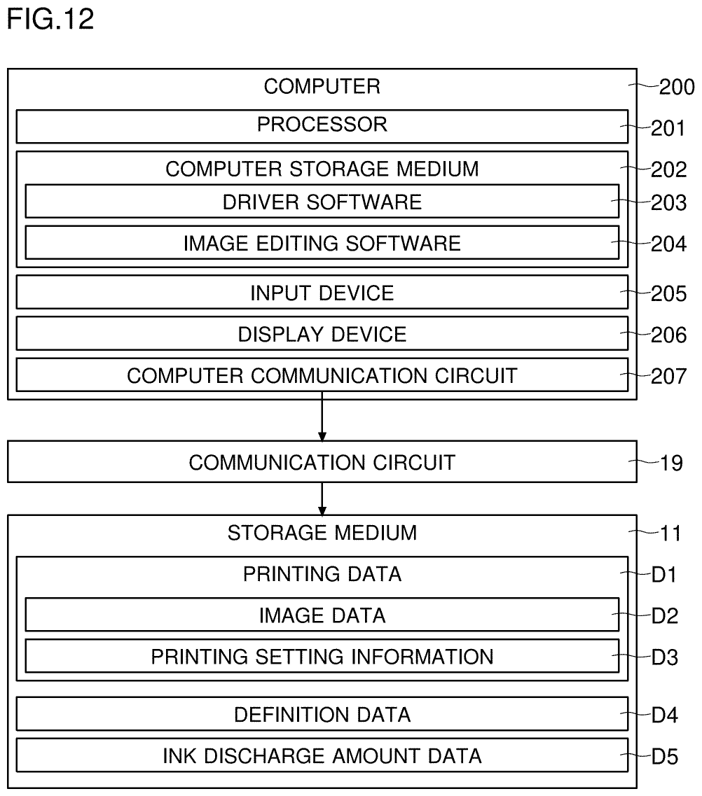

With reference to FIG. 12, the printing data D1 will be described. FIG. 12 shows an example of a flow of inputting the printing data D1 to the ink discharge device 1 according to the embodiment.

The computer 200 feeds the printing data D1 to the communication circuit 19 of the ink discharge device 1. The computer 200 can be considered as part of the printing device 100. The computer 200 includes a processor 201, a computer storage medium 202, an input device 205, a display device 206, and a computer communication circuit 207. The processor 201 is a circuit board including a processing circuit, such as a CPU. The computer storage medium 202 includes a ROM, a RAM, and an HDD. The computer storage medium 202 includes driver software 203 for generating the printing data D1. The computer storage medium 202 further includes image editing software 204 for editing the image data D2 to be used for printing. The input device 205 is a key board, a mouse, or the like. The user uses the input device 205 to edit the image data D2, and inputs a printing command. The display device 206 is a display. The computer communication circuit 207 is an interface that communicates with the printing device 100 and other devices.

The user uses the image editing software 204 to create and edit the image data D2 of an image to be printed on the fabric 7. For example, in a case of printing a bar code, the user creates image data D2 that includes an image of the bar code. In a case of printing a symbol string (a letter string), the user creates image data D2 including an image of the symbol string. In a case of printing a design (a figure, a pattern, a photograph, etc.), the user creates image data D2 including the design. Image data D2 externally downloaded into the computer 200 may be used for printing with respect to the fabric 7. In a case of printing a plurality of kinds of images with the ink discharge device 1 in one unit printing range E1 (prescribed distance F1×length of fabric 7 in perpendicular direction), image data D2 including the plurality of images is generated.

When the printing command is executed with the image editing software 204, the processor 201 activates the driver software 203. The processor 201, based on the driver software 203, makes the display device 206 display a screen for making printing settings. The input device 205 accepts the printing settings. For example, the input device 205 accepts the settings of a printing position of the image in a unit printing range E1, a printing resolution, a type of the image, and a discharge-time distance (details of which will be given later). For example, one resolution can be selected from among a plurality of resolutions available with the head 8.

The processor 201 generates the printing data D1 based on the driver software 203. The printing data D1 includes the image data D2 and printing setting information D3. The processor 201 generates the image data D2 at the selected resolution. The processor 201 has set information included in the printing setting information D3. For example, the processor 201 has information of the printing position, the printing resolution, the type of the image, the discharge-time distance (of which details will be given later), etc., included in the printing setting information D3. In a case where a plurality of types of images are to be printed in one unit printing range E1 by the ink discharge device 1, the processor 201 has the plurality of images included in the printing data D1.

Then, the processor 201 transmits, toward the communication circuit 19 of the ink discharge device 1, the generated printing data D1. As a result, the printing data D1 is fed to the ink discharge device 1. The storage medium 11 stores therein the received printing data D1. The ink discharge device 1 performs printing in a unit printing range E1 based on the image data D2 included in the printing data D1. The ink discharge device 1 repeats printing in a unit printing range E1 each time the fabric 7 is conveyed by the prescribed distance F1. For example, the printing device 100 can print an image of a code, a symbol string, a design, or the like in a unit printing range E1 of the fabric 7.

Here, it may be only the image data D2 that is fed from the computer 200. In this case, the operation panel 15 of the ink discharge device 1 accepts the printing settings. The controller 10 of the ink discharge device 1 generates the printing data D1.

(Printing by Ink Discharge Device 1)

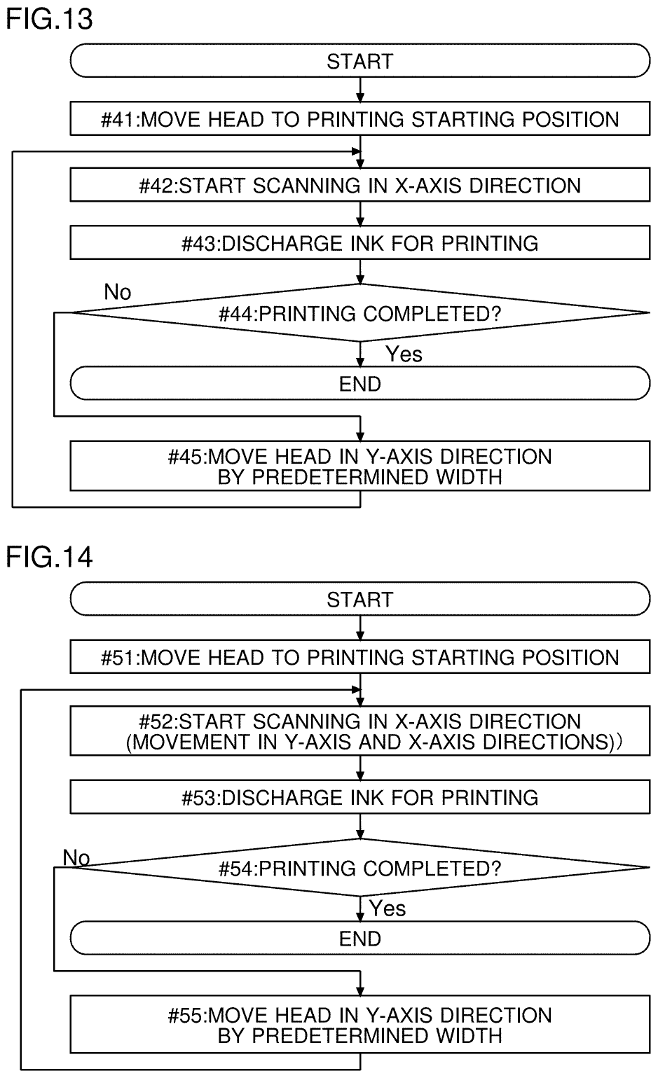

Next, with reference to FIG. 13 to FIG. 15, a description will be given of an example of printing performed by using the head 8 according to the embodiment. FIG. 13 is a diagram showing an example of printing in a stationary-target printing mode according to the embodiment. FIG. 14 is a diagram showing an example of printing in a conveyed-target printing mode according to the embodiment. FIG. 15 is a diagram showing an example of the movement of the head 8 in each printing mode according to the embodiment. In FIG. 15, illustration of the movement mechanisms and the conveyance device 3 is omitted.

In the printing device 100, conveyance of the fabric 7 and temporary suspension of the conveyance of the fabric 7 are repeated. On the other hand, the ink discharge device 1 can move the head 8 in the Y-axis direction (the conveyance direction) of the fabric 7. Accordingly, the ink discharge device 1 can perform printing with respect to the fabric 7 in the stationary state. The ink discharge device 1 can also perform printing with respect to the fabric 7 under conveyance. In the following description, the mode in which the ink discharge device 1 performs printing with respect to the fabric 7 while the fabric 7 is being stationary will be referred to as the stationary-target printing mode. The mode in which the ink discharge device 1 performs printing with respect to the fabric 7 while the fabric 7 is being conveyed will be referred to as the conveyed-target printing mode.

Selection can be made between the stationary-target printing mode and the conveyed-target printing mode via the operation panel 15. The operation panel 15 accepts selection between the stationary-target printing mode and the conveyed-target printing mode. In whichever mode, the controller 10 makes the head 8 perform printing with respect to the fabric 7 while moving the head 8 in the Y-axis direction.

1. Stationary-Target Printing Mode

To make the ink discharge device 1 start printing in association with stopping of the conveyance of the fabric 7, the stationary-target printing mode is selected.

With reference to FIG. 13, a description will be given of an example of a flow of printing performed in the stationary-target printing mode in one region of the prescribed distance F1 (unit printing range E1). The fabric 7 is sectioned into a plurality of unit printing ranges E1. The ink discharge device 1 performs printing of a same image in each unit printing range E1. In other words, the processing illustrated in FIG. 13 is performed in each of the unit printing ranges E1.

“START” in FIG. 13 is a time point at which printing in the stationary-target printing mode is started. In the stationary-target printing mode, “START” is a time point at which the conveyance device 3 stops conveying the fabric 7. The controller 10 may recognize the suspension of the conveyance of the fabric 7 based on notification of the suspension of the conveyance received from the conveyance device 3. The controller 10 may recognize suspension of the conveyance of the fabric 7 based on the output of the speed sensor 14.

First, the controller 10 moves the head 8 to a printing starting position (step #41). The printing starting position is determined in advance. For example, the printing starting position is a position at which a downstream-side corner of a unit printing range E1 and a most downstream-side nozzle 81 of the nozzle arrays 80 directly face each other. Here, the controller 10 may recognize the printing starting position based on the printing setting information D3 corresponding to the image data D2. In this case, the controller 10 makes the head 8 move to the recognized printing starting position.

Next, the controller 10 starts scanning (step #42). Scanning is an operation of making the head 8 move in the X-axis direction (a perpendicular direction with respect to the Y-axis direction). Scanning is an operation of making the head 8 move from one end to the other end of a unit printing range E1 in the X-axis direction. Scanning is performed in this manner, because the nozzle arrays 80 are parallel to the Y-axis direction. The controller 10 fixes the position of the head 8 in the Y-axis direction from the start till the end of one event of scanning. The starting position of one event of scanning is a position at which one of sides of the fabric 7 that are parallel to the Y-axis direction and a most other-side one of the nozzle arrays 80 face each other. The ending position of one event of scanning is a position at which the other one of the sides of the fabric 7 that are parallel to the Y-axis direction and a most one-side one of the nozzles arrays 80 face each other. The controller 10 makes the second movement mechanism B move the head 8. The head 8 discharges ink at an ink discharge cycle determined in advance. The head 8 is moved at a moving speed such that the head 8 moves, in one ink discharge cycle, by a distance corresponding to one dot of the printing resolution.

In association with the start of the scanning with the head 8 in the X-axis direction, the controller 10 performs printing by discharging ink based on the printing data D1 (step #43). In other words, based on the printing data D1, the controller 10 makes ink droplets impact pixels on which ink is to be put (part with respect to which the screen plate 22 does not perform printing). At the end of the scanning, the controller 10 confirms whether or not printing in the unit printing range E1 has been completed (step #44). When the printing in the unit printing range E1 is completed (Yes in step #44), the present flow ends (END). At the end of the printing in the unit printing range E1, the controller 10 may perform the flushing processing.

When the printing in the unit printing range E1 has not been completed (No in step #44), the controller 10 makes the head 8 move by a predetermined width G1 in the Y-axis direction (step #45). The controller 10 makes the third movement mechanism C move the head 8. A length of each nozzle array 80 of the head 8 in the Y-axis direction is shorter than a length of the unit printing range E1 in the Y-axis direction. To perform printing in the entire unit printing range E1, the position of the head 8 in the Y-axis direction is displaced. In a case where printing is performed from the downstream side of the unit printing range E1 in the conveyance direction (the Y-axis direction), the controller 10 displaces the head 8 toward the upstream side in the conveyance direction (the Y-axis direction). In a case where printing is performed from the upstream side of the unit printing range E1 in the conveyance direction (the Y-axis direction), the controller 10 displaces the head 8 toward the downstream side in the conveyance direction (the Y-axis direction).

After moving the head 8 in the Y-axis direction, the controller 10 makes the movement unit 12 (the second movement mechanism B) start next scanning (the flow returns to step #42). In this manner, in the stationary-target printing mode in which printing is performed with respect to the fabric 7 in the stationary state, the control device 4 makes the conveyance device 3 stop conveying the fabric 7 each time the fabric 7 is conveyed by the prescribed distance F1. Then, the ink discharge device 1 performs printing with respect to the fabric 7 in the stationary state. When the printing with the head 8 is completed, the control device 4 makes the conveyance device 3 restart to convey the fabric 7. Further, in the stationary-target printing mode, the controller 10 makes the movement unit 12 move the head 8 in the Y-axis direction and in the X-axis direction.

2. Conveyed-Target Printing Mode

To perform printing with respect to the fabric 7 under conveyance, the conveyed-target printing mode is selected. In the conveyed-target printing mode, printing can be performed while moving the head 8 in the Y-axis direction.

With reference to FIG. 14, a description will be given of an example of a flow of printing in the conveyed-target printing mode in one region of the prescribed distance F1 (unit printing range E1). A roll of the fabric 7 is sectioned into a plurality of unit printing ranges E1. The ink discharge device 1 performs printing of a same image in each unit printing range E1. The processing illustrated in FIG. 14 is performed in each of the unit printing ranges E1.

“START” in FIG. 14 is a time point at which printing in the conveyed-target printing mode is started. The conveyed-target printing mode starts at a time point at which the leading end of the fabric 7 enters the moving range of the head 8 or at a time point at which printing in the previous unit printing range E1 is completed.

First, the controller 10 moves the head 8 to a printing starting position (step #51). The printing starting position is determined in advance. For example, the printing starting position can be a position where the head 8 is moved to the most upstream side in the conveyance direction (Y-axis direction). In the X-axis direction, the printing starting position is a position at which a side of the fabric 7 parallel to the Y-axis direction and the nozzle arrays 80 directly face each other. Here, the controller 10 may recognize the printing starting position based on the printing setting information D3 corresponding to the image data D2. In this case, the head 8 is moved to the recognized printing starting position.

Next, the controller 10 starts scanning (step #52). In the conveyed-target printing mode, the controller 10 makes the second movement mechanism B move the head 8 in the X-axis direction (step #52). During scanning, the movement of the head 8 in the X-axis direction is similar to that in the stationary-target printing mode.

Further, it is necessary to prevent displacement of dot positions in the Y-axis direction. For this purpose, the controller 10 makes the third movement mechanism C move the head 8 in the Y-axis direction as well (step #52). The controller 10, during scanning, makes the third movement mechanism C move the head 8 in association with the fabric 7 conveyed, in such a manner that a relative speed between the fabric 7 and the head 8 in the Y-axis direction is zero. During scanning, the position of the head 8 (the nozzles 81) relative to the fabric 7 in the Y-axis direction is fixed. Based on the output of the speed sensor 14, the controller 10 recognizes the conveyance speed of the fabric 7. The controller 10 makes the moving speed of the head 8 in the Y-axis direction equal to the conveyance speed of the fabric 7.

In association with starting of the scanning with the head 8, the controller 10 performs printing by discharging ink based on the printing data D1 (step #53). In other words, based on the printing data D1, the controller 10 makes ink droplets impact pixels on which ink is to be put.

In association with ending of the scanning, the controller 10 confirms whether or not the printing in the unit printing range E1 has been completed (step #54). When the printing in the unit printing range E1 has been completed (Yes in step #54), the present flow ends (END). The controller 10 may perform flushing in association with the ending of the printing in the unit printing range E1.

When the printing in the unit printing range E1 has not been completed yet (No in step #54), the controller 10 makes the third movement mechanism C move the head 8 in the Y-axis direction by the predetermined width G1 (step #55). The controller 10 makes the third movement mechanism C move the head 8. To perform printing in the entire unit printing range E1, the position of the head 8 in the Y-axis direction is displaced. To perform printing with respect to the fabric 7 while the fabric 7 is being conveyed, in the unit printing range E1, the controller 10 displaces the head 8 toward the downstream side in the conveyance direction (the Y-axis direction).

After one even of scanning is completed, the controller 10 makes the third movement mechanism C move the head 8 in the Y-axis direction such that an amount of the movement in the Y-axis direction with respect to the fabric 7 under conveyance is equal to the predetermined width G1. The fabric 7 is being conveyed and thus is moving. Taking the movement by the conveyance into consideration, the controller 10 makes the head 8 move such that the position of the head 8 (impact position of an ink droplet from one same nozzle 81) is displaced by the predetermined width G1.

After moving the head 8 in the Y-axis direction, the controller 10 makes the movement unit 12 (the second movement mechanism B, the third movement mechanism C) start next scanning (the flow returns to step #52). Thus, in the conveyed-target printing mode in which printing is performed with respect to the fabric 7 while the fabric 7 is being conveyed, the controller 10 moves the position of the head 8 in the X-axis direction and in the Y-axis direction.

Next, with reference to FIG. 15, the predetermined width G1 will be described. In FIG. 15, regions sectioned by two-dot chain lines are each a unit printing range E1. The positions of the head 8 indicated by broken lines in FIG. 15 are examples of a position (state) that the head 8 takes after being moved by the predetermined width G1.

Here, in the head 8 of the ink discharge device 1, a number of nozzles included in a unit length (1 inch) of each nozzle array 80 is equal to or less than a number of dots per unit length (1 inch) of a settable printing resolution. The predetermined width G1 is shorter than the length of the nozzle arrays 80 in the Y-axis direction. Thus, where the length of the nozzle arrays 80 is represented by A, the printing resolution is represented by B, and the number of nozzles included in a unit length of each nozzle array 80 is represented by C, the predetermined width G1 is equal to (A÷(B÷C))+1 dot.

For example, assume that 600 nozzles 81 are included in each nozzle array 80. Also assume that the printing resolution is 600 dpi, and the number of nozzles included in the unit length of each nozzle array 80 is 150 (150 dpi). The unit length is 1 inch, which is equal to the unit length of the resolution. In this case, the length A of the nozzle arrays 80 is about 4 inches (600÷150). These values are substituted in the above formula, such that (A÷(B÷C))=4÷(600÷150)=1. Accordingly, in a case of printing at the resolution of 600 dpi, the predetermined width G1 is equal to 1 inch and 1 dot.

Assume that 600 nozzles 81 are included in each nozzle array 80. Also assume that the printing resolution is 300 dpi and the number of nozzles included in the unit length of each nozzle array 80 is 150. In this case as well, the unit length is 1 inch, which is equal to the unit length of the resolution. The length A of the nozzle arrays 80 is about 4 inches (600÷150). These values are substituted in the above formula, such that (A÷(B÷C))=4÷(300÷150)=2. Accordingly, in the case of printing at the resolution of 300 dpi, the predetermined width G1 is 2 inches and 1 dot.

Even when the number of nozzles included in the unit length of the nozzles 81 is smaller than that of the printing resolution, the number of ink droplets impacting in a unit area (1 square inch) can be made equal to the number of pixels in the unit area based on the printing resolution. The printing resolution can be achieved in a pseudo manner. In the ink discharge device 1, with respect to a certain dot, ink is discharged four times or two times. Position displacement by a distance corresponding to one dot makes it possible to scatter positions of nozzles 81 that discharge ink. This helps make clogging of the nozzles 81 less likely to occur.

Here, in accordance with the conveyance speed of the fabric 7, the reference cycle of ink discharge and the moving speed of the head 8 in the perpendicular direction may be changed. As the conveyance speed of the fabric 7 is higher, the fabric 7 is conveyed by the prescribed distance F1 in a shorter time. To finish printing in a unit printing range E1 before the conveyance of the fabric 7 is stopped, the controller 10 may shorten the cycle of the drive signal S1. The controller 10 may increase the moving speed of the head 8 in the perpendicular direction. That is, the controller 10 may adjust the drive signal S1 and the moving speed of the head 8 in the perpendicular direction such that ink is discharged once each time the fabric 7 move by the distance corresponding to one dot.

As the cycle of the drive signal S1 is shorter and the moving speed of the head 8 in the perpendicular direction is higher, more ink is discharged from the nozzles 81 in a unit time. As the cycle of the drive signal S1 is longer and the moving speed of the head 8 in the perpendicular direction is lower, less ink is discharged from the nozzles 81 in the unit time. To print a higher-density image on the fabric 7, the controller may increase the amount of ink to be discharged as a smaller amount of ink is discharged in the unit time.

Here, the conveyed-target printing mode and the stationary-target printing mode may be combined. For example, the controller 10 starts printing in a unit printing range E1 in the conveyed-target printing mode. Then, if printing is not completed in the unit printing range E1 by the time when the conveyance of the fabric 7 is stopped, the controller 10 may perform printing in the unprinted part of the unit printing range E1 in the stationary-target printing mode.

(Setting of Distance Between Nozzles 81 and Printing Surface 71)

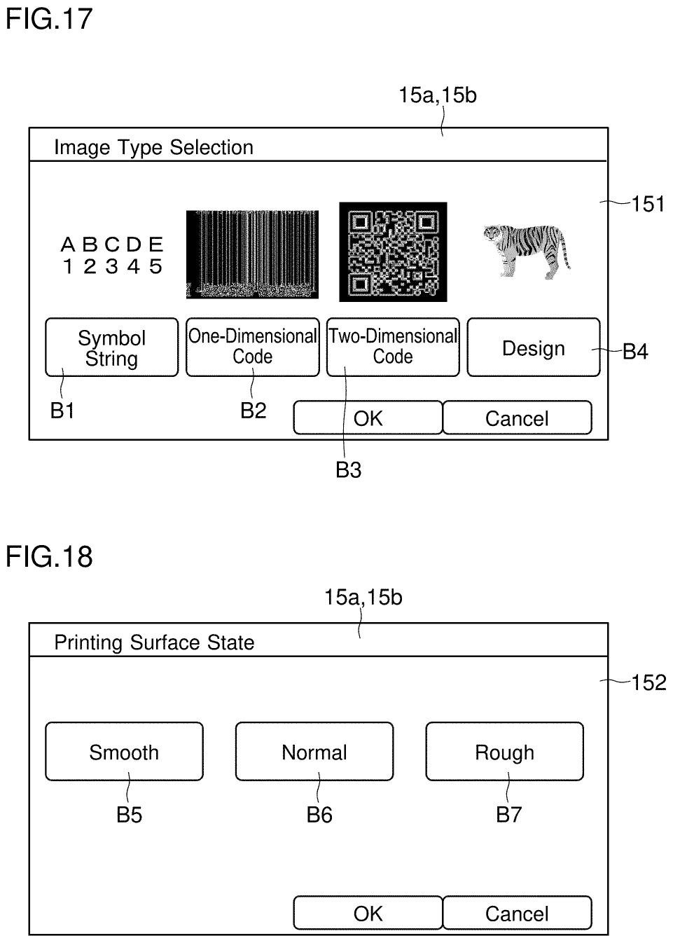

Next, with reference to FIG. 16 to FIG. 18, a description will be given of an example of setting of a distance between the nozzles 81 and the printing surface 71 according to the embodiment. FIG. 16 shows an example of definition data D4 according to the embodiment. FIG. 17 shows an example of an image type selection screen 151 according to the embodiment. FIG. 18 shows an example of a smoothness level selection screen 152 according to the embodiment.

The ink discharge device 1 can move the head 8 with respect to the printing surface 71 in the Z-axis direction (a direction perpendicular to a plane surface of the fabric 7). Accordingly, the ink discharge device 1 can adjust the distance between the printing surface 71 of the fabric 7 and the nozzles 81. The controller 10 sets a discharge-time distance in accordance with an image to be printed or the fabric 7. The discharge-time distance is a distance between the nozzles 81 and the printing surface 71 taken while ink is being discharged (during printing in a unit printing range E1). The controller 10 makes the movement unit 12 move the head 8 in the Z-axis direction with respect to the printing surface 71 to achieve the set discharge-time distance. A plurality of methods are prepared as methods for setting the discharge-time distance.

1. Distance Setting Based on Printing Setting Information D3

The controller 10 can set the discharge-time distance based on the printing setting information D3. The printing setting information D3 is included in the printing data D1. The printing setting information D3 is associated with the image data D2 which is used for image printing.

The printing setting information D3 includes information set on the driver software 203 of the computer 200. In a case where the printing setting information D3 includes information indicating an image type, the controller 10 can set the discharge-time distance based on the image type defined in the printing setting information D3.

To set the discharge-time distance in accordance with the image type, the storage medium 11 may store therein the definition data D4 in a non-volatile manner (see FIG. 12). The definition data D4 is data that defines the discharge-time distance for each image type. FIG. 16 shows an example of the definition data D4. In the definition data D4 shown in FIG. 16, it is defined that the discharge-time distance is 5 mm when the image type is a symbol string. Symbols include letters and digits. Symbol strings include a corporate name, a mail address, a phone number, and a date and time. Symbol strings are mainly composed of letters and digits arranged in a row.

In the definition data D4 shown in FIG. 16, it is also defined that the discharge-time distance is 1 mm when the image type is a two-dimensional code or a design (a pattern). A two-dimensional code is, for example, a QR code (registered trade mark). In the definition data D4 shown in FIG. 16, it is also defined that the discharge-time distance is 3 mm when the image type is a one-dimensional code. A one-dimensional code is, for example, a bar code. Here, the definition data D4 may also include other image types in addition to the image types of the two-dimensional code, one-dimensional code, and symbol string, and the discharge-time distances for such image types.

The longer the distance between the printing surface 71 and the nozzles 81 is, the longer the time from discharge till impact of an ink droplet is. As the time from discharge till impact is longer, ink droplets receive more influence from the gravity, an air flow, etc. Thus, a longer distance between the printing surface 71 and the nozzles 81 makes it more likely that ink droplets' impact positions are displaced from their target impact positions. On the other hand, a shorter distance between the printing surface 71 and the nozzles 81 makes it possible to print a more precise image.

Thus, the definition data D4 may be defined such that the more precisely an image is to be printed, the shorter the discharge-time distance is. For example, a two-dimensional code includes a dot. Based on a dimension of the dot (a block), information included in the code is obtained. If the dot has a blurred outline, or if it has an inappropriate dimension, it may prevent correct reading of information from the two-dimensional code. To prevent this, the definition data D4 is defined such that the discharge-time distance is of a minimum level when the image type is a two-dimensional code. It is also preferable for an image of a design to be printed in detail and precisely. Thus, the definition data D4 is defined such that the discharge-time distance is of the minimum level when the image type is a design.

In a case where the distance between the printing surface 71 and the nozzles 81 is short, the nozzles 81 is likely to collide with the fabric 7. The printing surface 71 of the fabric 7 is not always flat. The fabric 7 can have a rough surface. The risk of the fabric 7 and the nozzles 81 coming into contact with each other is not zero. If the printing surface 71 and the nozzles 81 repeatedly come into contact with each other, it may damage the nozzles 81 (the head 8). In view of preventing such contact, it is more preferable for the printing surface 71 and the nozzles 81 to be spaced from each other by a long distance.

Thus, in the definition data D4, the discharge-time distance may be set longer for an image with less need of precise printing. For example, a symbol string (a letter string) includes a large solid area. Minor displacement of ink impact positions will cause no problem. Further, properly scattered ink-droplet impact positions may make color unevenness unlikely to occur. FIG. 16 shows an example of the definition data D4 in which the discharge-time distance is made relatively long when the image type is a symbol string. One-dimensional codes are scanned. Thus, one-dimensional codes need to be printed precisely to some extent. On the other hand, one-dimensional codes do not need to be printed so precisely as two-dimensional codes. FIG. 16 shows an example of the definition data D4 in which, when the image type is a one-dimensional code, the discharge-time distance is set shorter than when the image type is a symbol string but longer than when the image type is a two-dimensional code.

Here, the printing setting information D3 may include information (a value) indicating the discharge-time distance. In this case, the input device 205 of the computer 200 accepts input of a numerical value of the discharge-time distance. Based on the driver software 203, the processor 201 generates the printing setting information D3 (the printing data D1) that includes the discharge-time distance inputted as the numerical value. When the printing setting information D3 associated with the image data D2 includes the information indicating the value of the discharge-time distance, the controller 10 sets the discharge-time distance based on the value included in the printing setting information D3.

2. Discharge-Time Distance Setting Based on Image Data D2

The controller 10 may set the discharge-time distance based on the image data D2. In this case, the controller 10 analyzes the image data D2. Then, the controller 10 judges the type of the image included in the image data D2. Then, the controller 10 may set the discharge-time distance based on the judged image type and the definition data D4. Here, in a case where a plurality of pieces of image data D2 are used (superimposed as layers) for printing with respect to one fabric 7, the controller 10 judges the type of the image included in each of the plurality of pieces of image data D2. The controller 10 sets the discharge-time distance with respect to each of the plurality of pieces of image data D2.

For example, the controller 10 confirms whether or not the image included in the image data D2 is an image of a two-dimensional code. For example, the controller 10 confirms whether or not a figure essential in the standard for the two-dimensional code is included in the image data D2. If an essential figure is included, the controller 10 judges that the image is an image of a two-dimensional code. The controller 10 also confirms whether or not the image included in the image data D2 is an image of a one-dimensional code. For example, the controller 10 confirms whether or not parallel straight lines of a number specified in the standard for the one-dimensional code are included in the image data D2. If parallel straight lines of the number specified in the standard for the one-dimensional code are included, the controller 10 judges that the image is an image of a one-dimensional code. The controller 10 also confirms whether or not the image included in the image data D2 is an image of a symbol string (a letter string). For example, the controller 10 confirms whether or not the image data D2 includes an alphabet letter. If an alphabet letter is included, the controller 10 may judge that the image is an image of a symbol string. If the image included in the image data D2 is an image of none of a two-dimensional code, one-dimensional code, and a symbol string, the controller 10 may judge that the image is an image of a design. The controller 10 sets the discharge-time distance based on the thus judged image type and the definition data D4.

Here, in a case where two or more of a two-dimensional code, a design, a one-dimensional code, and a symbol string are included in the image data D2, the controller 10 applies a minimum or maximum one of the discharge-time distances for the plurality of image types.

3. Discharge-Time Distance Setting Via Operation Panel 15

The operation panel 15 may accept the selection of the type of an image to be printed. In response to a predetermined operation, the controller 10 makes the display panel 15a display the image type selection screen 151. The user touches the screen to select an image type.

FIG. 17 shows an example of the image type selection screen 151. On the image type selection screen 151 shown in FIG. 17, the user can select one image type out of four image types. A first selection button B1, a second selection button B2, a third selection button B3, and a fourth selection button B4 are displayed within the image type selection screen 151. When the image is an image of a symbol string, the user operates the first selection button B1. When the image is an image of a one-dimensional code, the user operates the second selection button B2. When the image is an image of a two-dimensional code, the user operates the third selection button B3. When the image is an image of a design, the user operates the fourth selection button B4.

In the definition data D4, the discharge-time distance is determined for each of selectable image types. For example, for a symbol string image, the discharge-time distance is 5 mm. For a one-dimensional code image, the discharge-time distance is 3 mm. For a two-dimensional code image and a design image, the discharge-time distance is 1 mm. The controller 10 sets the discharge-time distance based on the image type selected via the operation panel 15 and the definition data D4. In addition to the symbol string, one-dimensional code, two-dimensional code, and design image types, other image types may be included in the selectable image types. When the symbol string has been selected as the image type, the controller 10 sets the discharge-time distance to a first distance. When the one-dimensional code has been selected as the image type, the controller 10 sets the discharge-time distance to a second distance which is shorter than the first distance. When the two-dimensional code or the design has been selected as the image type, the controller 10 sets the discharge-time distance to a third distance which is shorter than the second distance. As long as the relationship, 1st distance>2nd distance>3rd distance, is maintained, the first distance does not need to be 5 mm. Likewise, the second distance does not need to be 3 mm. The third distance does not need to be 1 mm.

4. Discharge-Time Distance Setting Based on Smoothness Level of Surface of Fabric 7

The fabric 7 conveyed on the line (the conveyance device 3) is not always of the same type. That is, the ink discharge device 1 can perform printing with respect to the fabric 7 of various types. For example, a printing object can be different roll by roll of the fabric 7. Different rolls of the fabric 7 can be different from each other in material, dimension, and surface smoothness.

Ink is more likely to be blurred on a rougher surface. On the other hand, on a rough surface, intentional displacement of ink impact positions may contribute to printing of an image with less unevenness. This is because ink can be made to sink also into minute recesses in the surface of the fabric 7. Also, the smoother the surface of the fabric 7 is, the more noticeable displacement of ink impact positions tends to be.

Thus, the operation panel 15 may accept a setting of the smoothness level of the surface of the fabric 7. In response to a predetermined operation, the controller 10 makes the display panel 15a display the smoothness level selection screen 152. The user touches the screen to select a state of the printing surface 71 of the fabric 7.

FIG. 18 shows an example of the smoothness level selection screen 152. On the smoothness level selection screen 152 shown in FIG. 18, one can be selected out of three levels. A fifth selection button B5, a sixth selection button B6, and a seventh selection button B7 are displayed within the smoothness level selection screen 152. For printing with respect to the fabric 7 having a surface of a high smoothness level (smooth surface), the fifth selection button B5 is operated. For printing with respect to the fabric 7 having a surface of a normal smoothness level, the sixth selection button B6 is operated. For printing with respect to the fabric 7 having a surface of a low smoothness level (rough surface), the seventh selection button B7 is operated.

For each of the smoothness levels to be selected, the discharge-time distance is determined in advance. In other words, the discharge-time distance corresponding to each of the selection buttons is determined in advance. For example, the discharge-time distance corresponding to the seventh selection button B7 is 5 mm. The discharge-time distance corresponding to the sixth selection button B6 is 3 mm. The discharge-time distance corresponding to the fifth selection button B5 is 1 mm. The controller 10 may set the discharge-time distance in accordance with the smoothness level selected via the operation panel 15. The controller 10 reduces the discharge-time distance as the set smoothness level is higher. The controller 10 increases the discharge-time distance as the set smoothness level is lower.

(Control of Movement of Head 8 in Z-Axis Direction)

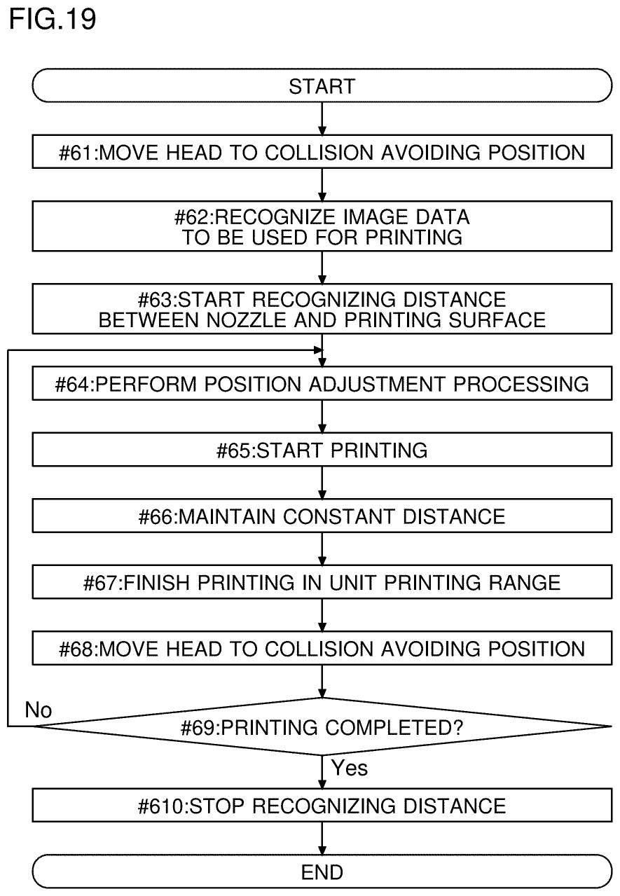

Next, with reference to FIG. 19, a description will be given of an example of control of the movement of the head 8 according to the embodiment in the Z-axis direction. FIG. 19 is a diagram showing an example of a flow of the movement of the head 8 according to the embodiment in the Z-axis direction.

“START” in FIG. 19 is a time point at which printing by using the ink discharge device 1 is started. In other words, it is a time point at which printing in a unit printing range E1 is started.

First, the controller 10 places the head 8 at a collision avoiding position in the Z-axis direction (step #61). The controller 10 makes the first movement mechanism A move the head 8 to the collision avoiding position. When the head 8 is at the collision avoiding position, the nozzles 81 are sufficiently separated from the printing surface 71. When the head 8 is at the collision avoiding position, the fabric 7 does not come into contact with the nozzles 81 even if it swings. The collision avoiding position can be appropriately determined. The collision avoiding position may be a position at which the nozzles 81 and the printing surface 71 are separated from each other in the Z-axis direction by a distance that is two times to several times as long as the maximum value of the discharge-time distance. The collision avoiding position may be any place as long as the head 8 and the fabric 7 are sufficiently separated from each other. To the collision avoiding position, there is no particular positional restriction in the Y-axis direction or in the X-axis direction.

Subsequently, the controller 10 recognizes the image data D2 to be used for printing (step #62). The discharge-time distance can be set based on the printing setting information D3, the image data D2, or the selection made via the operation panel 15. Even when an image type has been selected in the printing setting information D3, the controller 10 gives priority to the selection made via the operation panel 15.

Specifically, the user makes a selection on the image type selection screen 151 or the smoothness level selection screen 152 to set the discharge-time distance. Transmission of the printing data D1 from the computer 200 to the ink discharge device 1 and the making of settings on each selection screen are performed before the conveyance device 3 starts to convey the fabric 7. In a case where a selection has been made on each of the image type selection screen 151 and the smoothness level selection screen 152, the controller 10 may give priority to the selection made on the image type selection screen 151. In this case, the controller 10 sets the discharge-time distance corresponding to the button selected on the image type selection screen 151. Or, the priority may be given to the selection made on the smoothness level selection screen 152. In this case, the controller 10 sets the discharge-time distance corresponding to the button selected on the smoothness level selection screen 152.

In a case where a selection has not been made on either selection screen, the controller 10 sets the discharge-time distance based on the printing setting information D3. Even if no selection is made via the operation panel 15, the controller 10 automatically sets the discharge-time distance. When the printing setting information D3 does not include either information indicating the image type or a value indicating the discharge-time distance, the controller 10 analyzes the image data D2 to set the discharge-time distance.

Based on an output of a distance sensor 17, the controller 10 starts to recognize the distance between the nozzles 81 and the printing surface 71 (step #63). In a case of printing with respect to a first unit printing range E1, the controller 10 starts to recognize a distance at a time point when the printing surface 71 of the fabric 7 comes in front of the distance sensor 17 (the head 8).

Then, the controller 10, before starting printing in the unit printing range E1, performs position adjustment processing (step #64). In the position adjustment processing, the controller 10 makes the movement unit 12 move the head 8 in the Z-axis direction. Then, the controller 10 makes the distance between the nozzles 81 and the printing surface 71 equal to the set discharge-time distance. Specifically, the controller 10 makes the movement unit 12 move the head 8 such that the distance detected by the distance sensor 17 becomes equal to the discharge-time distance. The controller 10 makes the head 8 approach the fabric 7.

Before long, printing (scanning) with the head 8 is started (step #65). During printing (scanning) in the unit printing range E1, for the purpose of maintaining a constant distance, the controller 10, as necessary, makes the movement unit 12 (the first movement mechanism A) move the head 8 in the Z-axis direction (step #66). The controller 10 keeps the distance equal to the discharge-time distance. During printing, the controller 10 continuously monitors the output of the distance sensor 17. If the recognized distance becomes different from the discharge-time distance, the controller 10 makes the movement unit 12 move the head 8 in the Z-axis direction with respect to the printing surface 71. In other words, in order to keep the distance equal to the discharge-time distance, the controller 10 performs feedback control based on the output of the distance sensor 17. The controller 10 makes the position of the head 8 in the Z-axis direction follow the roughness of the printing surface 71 of the fabric 7. Even if the printing surface 71 of the fabric 7 is a rough surface, the nozzles 81 and the fabric 7 do not collide with each other. In due course, the printing in the unit printing range E1 is completed (step #67).

When the printing in the unit printing range E1 is completed, the controller 10 places the head 8 at the collision avoiding position in the Z-axis direction (step #68). Then, the controller 10 confirms whether or not printing has been completed with respect to the entire fabric 7 (step #69). In other words, the controller 10 confirms whether or not printing has been completed with respect to one whole roll of the fabric 7. If not (No in step #69), the flow returns to step #64. In preparation for printing in a next unit printing range E1, the controller 10 adjusts the position of the head 8 in the Z-axis direction. Before retraction to the collision avoiding position or between retraction to the collision avoiding position and the position adjustment processing, the flushing processing and the wiping processing may be performed with respect to the head 8.

When the printing is completed (Yes in step #69), the controller 10 stops recognizing the distance (step #610). This completes the present flow (END).

(Adjustment of Ink Discharge Amount in Accordance with Discharge-Time Distance)

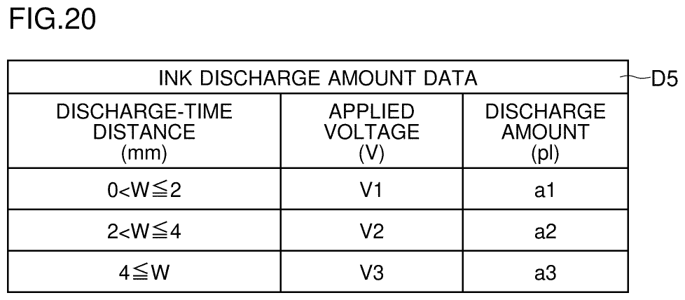

Next, with reference to FIG. 20, a description will be given of an example of adjustment of an ink discharge amount performed in the printing device 100 according to the embodiment. FIG. 20 is a diagram showing an example of ink discharge amount data D5 according to the embodiment.

The printing device 100 can move the head 8 in the Z-axis direction with respect to the printing surface 71. Thus, the distance between the nozzles 81 and the printing surface 71 of the fabric 7 is freely changeable. This makes the printing device 100 distinct from the conventional inkjet printing devices installed in a conveyance line. Here, a shorter discharge-time distance makes it more likely for ink droplets to impact their target impact positions. On the other hand, a longer discharge-time makes it more likely for actual impact positions of ink droplets to be displaced from their target positions. For example, an ink droplet may impact a dot that is, according to the image data D2, not to be colored. As a result, a printed image may appear to be thin in density.

To prevent this, the controller 10 makes the head 8 discharge less ink per dot as the discharge-time distance is shorter. The controller 10 makes the head 8 discharge more ink per dot as the discharge-time distance is longer.

The head 8 includes the voltage generation circuits 84 (see FIG. 6). The voltage generation circuit 84 generates a plurality of types of voltages. The voltage generation circuit 84 generates voltages of magnitudes set in advance. From among the plurality of types of voltages generated by the voltage generation circuit 84, a voltage to be applied to the drive element 83 can be selected. That is, the voltage to be applied to the drive element 83 can be changed.

Depending on the magnitude of the voltage applied to the drive element 83, an amount of deformation of the drive element 83 varies. Depending on the amount of deformation of the drive element 83, pressure is applied to the flow path of ink. The larger the amount of deformation is, the greater the pressure becomes. Accordingly, by selecting the magnitude of voltage to be applied to the drive element 83, the controller 10 (the driver circuit 82) can change the amount of ink (liquid droplets) to be discharged.

FIG. 20 is a diagram showing an example of the ink discharge amount data D5 according to the embodiment. The storage medium 11 stores therein the ink discharge amount data D5 in a non-volatile manner. The ink discharge amount data D5 is defined such that as the discharge-time distance is shorter, a smaller amount of ink is discharged per dot. The ink discharge amount data D5 is also defined such that as the discharge-time distance is longer, a larger amount of ink is discharged per dot.

FIG. 20 shows an example where the discharge-time distance is classified into three categories (three grades). That is, what is shown is an example where the voltage generation circuit 84 can generate at least three types of voltages. In FIG. 20, a relationship, voltage V1<voltage V2<voltage V3, holds. Thus, the following relationship holds as to the ink discharge amount (the amount of liquid droplets): first discharge amount a1<second discharge amount a2<third discharge amount a3.

According to the ink discharge amount data D5 shown in FIG. 20, when the discharge-time distance is 1 mm, the controller 10 has the voltage V1 applied to the drive element 83. The controller 10 makes the amount of ink to be discharged from the nozzles 81 equal to the first discharge amount a1. When the discharge-time distance is 3 mm, the controller 10 has the voltage V2 applied to the drive element 83. The controller 10 makes the amount of ink to be discharged from the nozzles 81 equal to the second discharge amount a2. When the discharge-time distance is 5 mm, the controller 10 has the voltage V3 applied to the drive element 83. The controller 10 makes the amount of ink to be discharged from the nozzles 81 equal to the third discharge amount a3. The controller 10 refers to the ink discharge amount data D5. And, in accordance with the set discharge-time distance, the controller 10 makes the head 8 discharge ink.

Here, another method may be adopted to adjust the ink discharge amount per dot. For example, the controller 10 may change timing (frequency) of discharging ink to one dot in accordance with the discharge-time distance. For example, when the discharge-time distance is such that 0 mm<W≤2 mm, the controller 10 may have ink discharged twice to one dot. When the discharge-time distance is such that 2 mm<W≤4 mm, the controller 10 may have ink discharged three times to one dot. When the discharge-time distance is such that 4 mm<W, the controller 10 may have ink discharged four times to one dot. For high-speed discharging of ink, the controller 10 may make the frequency of the drive signal S1 higher as the discharge-time distance is longer.

(Printing Based on Shooting Image of Printing Surface 71)

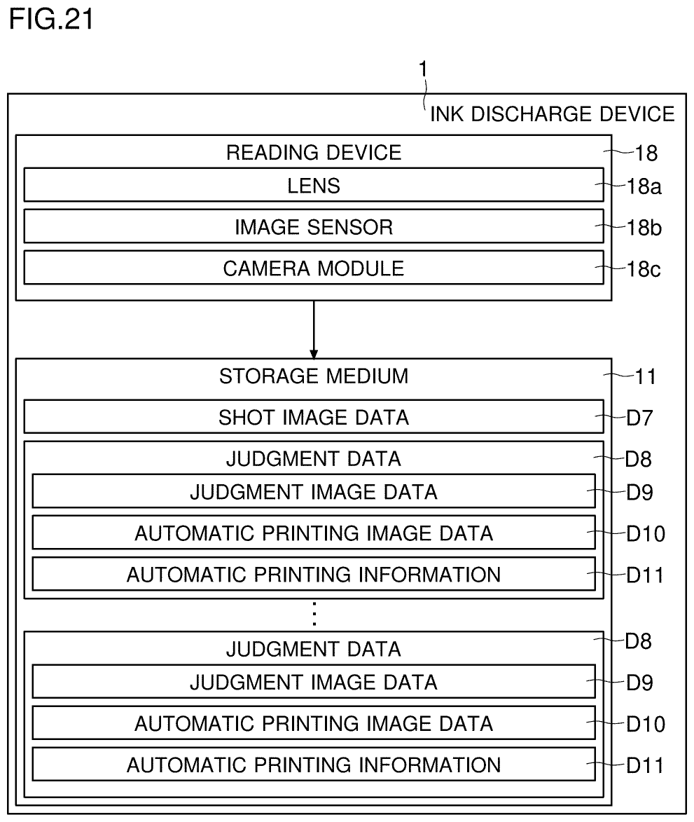

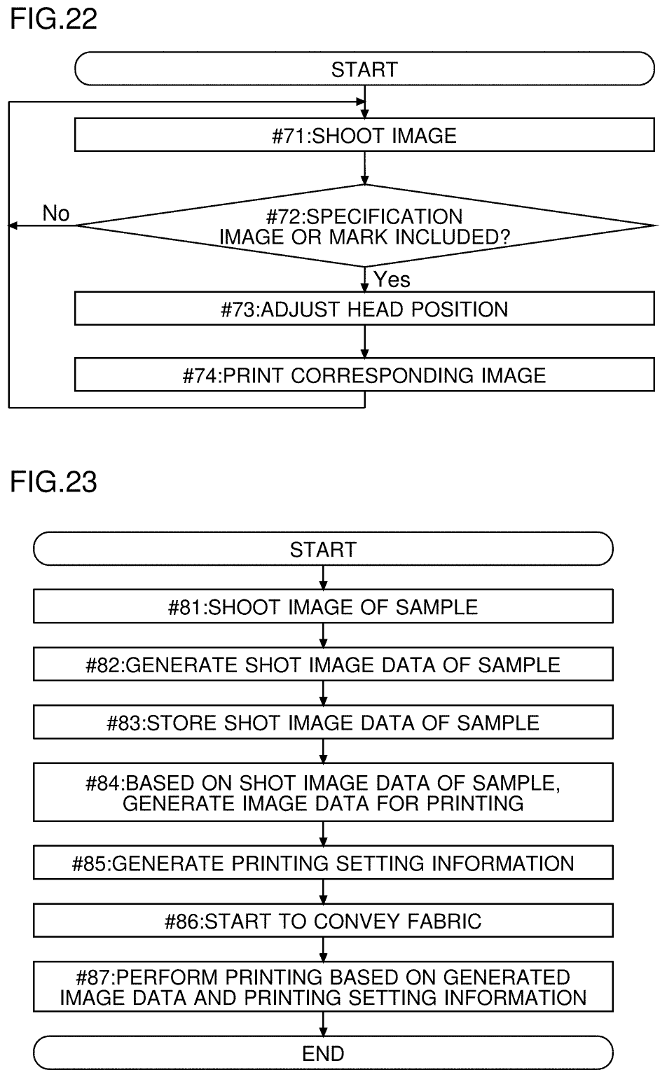

Next, with reference to FIG. 21 to FIG. 23, a description will be given of an example of printing performed based on image shooting according to the embodiment. FIG. 21 is a diagram showing an example of parts related to shooting an image of the printing surface 71 according to the embodiment. FIG. 22 is a diagram showing an example of a flow in an automatic image addition mode according to the embodiment. FIG. 23 is a diagram showing an example of a flow in a copy mode according to the embodiment.

The ink discharge device 1 includes a reading device 18 (see FIG. 1) which reads the printing surface 71 of the fabric 7. The reading device 18 may be separate from the ink discharge device 1. The reading device 18 includes a camera. The reading device 18 shoots an image of the fabric 7 placed on the conveyance line. For example, the reading device 18 shoots an image of a range in which the printing device 100 can perform printing.

As shown in FIG. 21, the reading device 18 includes a lens 18a, an image sensor 18b, and a camera module 18c. Based on an image signal that the image sensor 18b outputs, the camera module 18c generates shot image data D7 (image data). The reading device 18 transmits the shot image data D7, obtained by image shooting, to the storage medium 11. The storage medium 11 stores therein the shot image data D7.

The ink discharge device 1 has, as printing modes based on image shooting, the automatic image addition mode and the copy mode. A selection can be made via the operation panel 15 between printing in the automatic image addition mode and printing in the copy mode. The operation panel 15 accepts the selection between printing in the automatic image addition mode and printing in the copy mode.

1. Automatic Image Addition Mode

The automatic image addition mode is a mode of printing in which, based on a specification image or a specification mark marked on the fabric 7, an image corresponding to the specification image is printed on the fabric 7 by using the ink discharge device 1. In the automatic image addition mode, when a specification image or a specification mark is marked on the fabric 7, the controller 10 makes the head 8 automatically print a corresponding image on the printing surface 71. The specification image and the specification mark are not necessarily printed on the fabric 7. The specification image and the specification mark may be, for example, a seal.

For example, when an image indicating a language used is attached as a specification image, the ink discharge device 1 automatically prints a letter string of the corresponding language. Even in a case where printing is performed with respect to fabrics 7 to be delivered to different destinations, a letter string suitable to the delivery destination can be automatically printed on the fabric 7 by using the printing device 100. This saves trouble of specifying, via the computer 200 or the operation panel 15, the image data D2 of languages used or letter strings used, one by one.

For example, when a triangle mark, indicating that the delivery destination is Europe, is marked as the specification mark, the ink discharge device 1 automatically prints an image indicating that it is a product for Europe. By using the ink discharge device 1, an appropriate image can be automatically printed. There is no need of specifying, via the computer 200 or the printing device 100, delivery destinations one by one.

With reference to FIG. 22, a description will be given of an example of a flow of printing in the automatic image addition mode. “START” in FIG. 22 is, for example, a time point at which an instruction to perform printing in the automatic image addition mode is given via the operation panel 15. First, the controller 10 makes the reading device 18 start image shooting (step #71). The reading device 18 shoots an image of the fabric 7 that is being stationary or passing.

Here, the storage medium 11 stores therein judgment data D8 for judgment. The judgment data D8 is data for making a judgment on whether or not a specification image or a specific mark is marked on the fabric 7 (see FIG. 21). The judgment data D8 is prepared with respect to each specification image or mark. The controller 10, based on the judgment data D8, confirms whether or not the fabric 7 is marked with a specification image or a specification mark.

The judgment data D8 includes judgment image data D9 for judgment. The judgment image data D9 is image data indicating a specification image or a specification mark. For example, when the specification image is a set of digits indicating a model number, the judgment image data D9 is image data that indicates the model number and includes the digits.

The judgment data D8 includes automatic printing image data D10 for automatic printing. The automatic printing image data D10 is image data of an image to be printed corresponding to a specification image or a specification mark. The judgment data D8 also includes automatic printing information D11. The automatic printing information D11 includes, regarding the automatic printing image data D10, information of the printing starting position, the printing resolution, and the discharge-time distance for printing in the unit printing range E1. A distance from a feature point in the specification image or the specification mark in the X-axis direction and the Y-axis direction can be set as the printing starting position. The feature point may be, for example, any of an upper right corner, a lower right corner, an upper left corner, a lower left corner, and a center of the specification image or the specification mark. The automatic printing information D11 can be set via the computer 200 or the operation panel 15.

The controller 10 judges whether or not the shot image data D7 includes a specification image or a specification mark (step #72). For example, the controller 10 performs pattern matching between the judgment image data D9 and the shot image data D7. Then, the controller 10 judges whether or not the shot image data D7 includes a specification image or a specification mark.

When it is judged that the shot image data D7 does not include either a specification image or a specification mark (No in step #72), the flow returns to step #71. When it is judged that the shot image data D7 includes a specification image or a specification mark (Yes in step #72), the controller 10 makes the movement unit 12 adjust the position of the head 8 (step #73). The controller 10 moves the head 8 to a position that is away from the specification image or the specification mark by a distance defined in the automatic printing information D11.

After the position of the head 8 is adjusted, the controller 10 makes the head 8 print an image corresponding to the specification image or an image corresponding to the specification mark (step #74). The controller 10 has printing performed based on the automatic printing image data D10 corresponding to the specification image. Or, the controller 10 has printing performed based on the automatic printing image data D10 corresponding to the specification mark. In this manner, the image corresponding to the specification image, or the image corresponding to the specification mark, can be printed automatically. After the printing, the flow returns to step #71.

2. Copy Mode

The copy mode is a mode in which an image of a sample fabric 7 is shot and an image similar to the image on the sample is automatically printed on the printing surface 71. By using the copy mode, an image similar to that on the sample can be printed on an unprinted fabric 7 without editing the image data D2 on the computer 200.

With reference to FIG. 23, a description will be given of an example of a flow of printing in the copy mode. “START” in FIG. 23 is, for example, a time point at which an instruction to perform printing in the copy mode is given via the operation panel 15. First, the controller 10 makes the reading device 18 shoot an image of a sample (step #81). The user places the sample within an image shooting range of the reading device 18. The user sets the sample such that an image of the entire sample can be shot. After the setting, the user operates an image shooting button on the operation panel 15. In other words, the user releases a shutter for shooting an image of the sample.

The reading device 18 generates the shot image data D7 of the sample (step #82). The storage medium 11 stores therein the shot image data D7 of the sample (step #83). The controller 10, based on the shot image data D7 of the sample fabric 7, generates the image data D2 to be used for printing (step #84). The controller 10 generates the image data D2 of a size of the unit printing range E1. Further, the controller 10, with respect to each piece of the image data D2 generated, generates the printing setting information D3 (step #85). The controller 10 may automatically determine the discharge-time distance in accordance with the type of the image data D2.

Then, the sample fabric 7 is removed from the image shooting range. The control device 4 makes the conveyance device 3 start conveying a fabric 7 on which an image similar to the image on the sample is going to be printed (step #86). The controller 10, based on the image data D2 and the printing setting information D3 which have been generated, performs printing with respect to the fabric 7 (step #87). Then, the controller 10 makes the head 8 and the movement unit 12 perform printing of the image similar to the image on the sample with respect to the fabric 7 conveyed (END). The controller 10 makes the head 8 continue to perform printing of the image similar to the image on the sample on the fabric 7 until a rear end of the fabric 7 passes.

### Modified Example

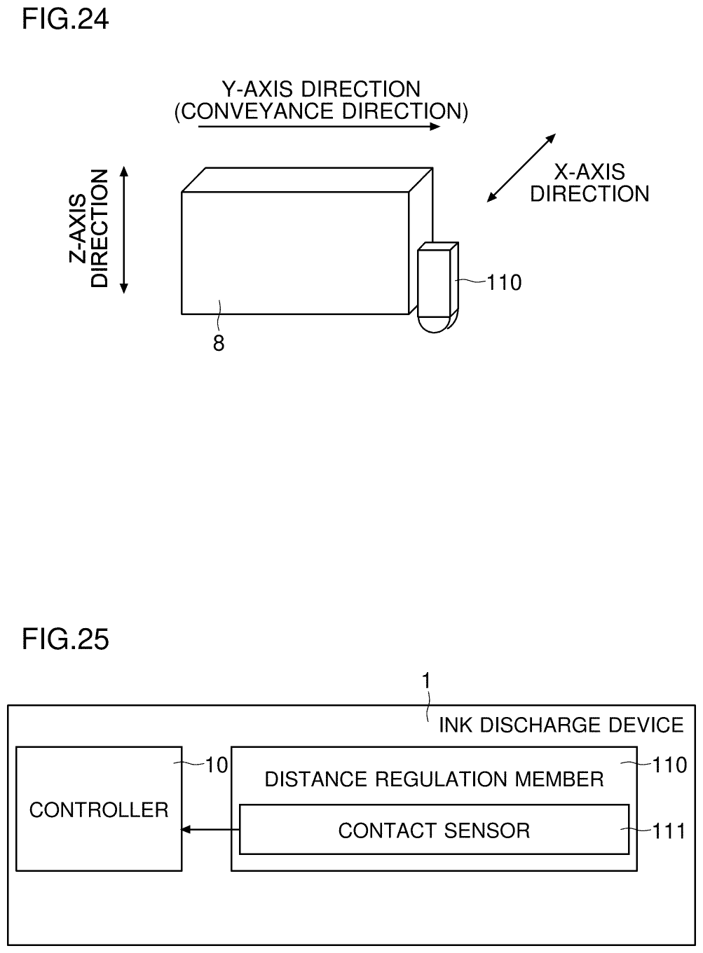

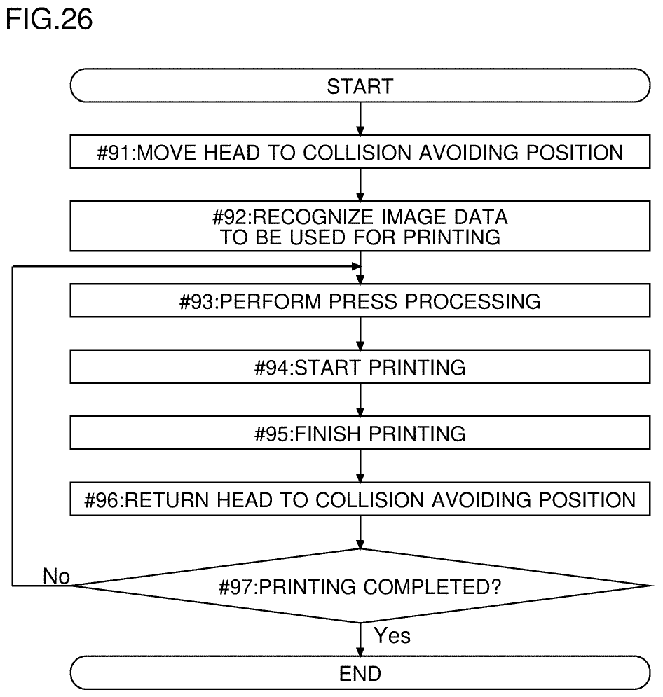

Next, with reference to FIG. 24 to FIG. 26, a description will be given of a modified example of the printing device 100 according to the embodiment. FIG. 24 is a diagram showing an example of the head 8 according to the modified example. FIG. 25 is a diagram showing an example of the ink discharge device 1 according to the modified example. FIG. 26 is a diagram showing an example of a flow of movement of the head 8 according to the modified example with respect to the printing surface 71 in the Z-axis direction.

As the ink discharge device 1 according to the embodiment, an example has been described in which the discharge-time distance is set in accordance with the image type of the image data D2, a setting made via the operation panel 15, etc. There has also been described an example in which the distance between the nozzles 81 and the printing surface 71 is adjusted, in accordance with the set discharge-time distance, by using the distance sensor 17. However, there is a case where the discharge-time distance does not need to be changed in accordance with the type of an image. In such a case, there is no need of using the distance sensor 17.

The modified example is an example without the distance sensor 17. In the modified example, a distance regulation member 110 is used instead of the distance sensor 17. The distance regulation member 110 regulates the distance between the nozzles 81 and the printing surface 71. During ink discharge, an end of the distance regulation member 110 on a side of the fabric 7 contacts the fabric 7. The distance regulation member 110 prevents the distance between the nozzles 81 and the printing surface 71 from becoming equal to or shorter than a reference distance. The reference distance is appropriately determined. The reference distance is, for example, any distance in a range of 1 mm to 5 mm.

The distance regulation member 110, in the Z-axis direction, projects more than the nozzles 81 (a lower face of the head 8) toward the printing surface of the fabric 7. The distance regulation member 110 projects by a length equal to the reference distance. Even when the head 8 or the fabric 7 swings so that the nozzles 81 and the fabric 7 approach each other, the distance regulation member 110 prevents the nozzles 81 and the fabric 7 from contacting each other. The distance regulation member 110 is attached to the lower face or a side face of the head 8. FIG. 24 shows an example where the distance regulation member 110 is attached to a side face of the head 8. The distance regulation member 110 contacts the fabric 7. On the other hand, the fabric 7 is conveyed. To prevent damage to the surface of the fabric 7 or interference (friction) with the conveyance of the fabric 7, the distance regulation member 110 can be a roller or a ball. The distance regulation member 110 turns in association with the movement of the fabric 7 or the head 8 in the Y-axis direction.

As shown in FIG. 25, the distance regulation member 110 includes a contact sensor 111 for detecting contact between the distance regulation member 110 and the fabric 7. For example, the contact sensor 111 is a pressure-sensitive sensor. When the distance regulation member 110 and the fabric 7 are in contact with each other, the contact sensor 111 outputs a voltage of a contacting-time level. On the other hand, when the distance regulation member 110 and the fabric 7 are out of contact with each other, the contact sensor 111 outputs a voltage of a non-contacting-time level. The controller 10, based on the output of the contact sensor 111, recognizes whether or not the distance regulation member 110 and the fabric 7 are in contact with each other.

Next, with reference to FIG. 26, a description will be given of an example of control of the movement of the head 8 of the ink discharge device 1 according to the modified example in the Z-axis direction. “START” in FIG. 26 is a time point at which printing in a unit printing range E1 is started. First, the controller 10 places the head 8 at the collision avoiding position in the Z-axis direction (step #91). Subsequently, the controller 10 recognizes the image data D2 to be used for the printing (step #92).

Then, the controller 10, before printing, performs press processing (step #93). During the press processing, the controller 10 makes the movement unit 12 (the first movement mechanism A) move the head 8 in the Z-axis direction until the output of the contact sensor 111 changes from the non-contacting-time level to the contacting-time level. In other words, the controller 10 makes the head 8 approach the fabric 7. The controller 10 makes the head 8 continue to move until the distance between the nozzles 81 and the printing surface 71 becomes equal to the reference distance. At a time point at which the output of the contact sensor 111 changes from the non-contacting-time level to the contacting-time level, the controller 10 immediately makes the movement unit 12 stop the movement in the Z-axis direction.

Before long, printing by the head 8 is started (step #94). During the printing of an image, the distance regulation member 110 prevents the distance from becoming shorter than the reference distance. Before long, the printing in the unit printing range E1 is completed (step #95).

Then, the controller 10 returns the position of the head 8 in the Z-axis direction with respect to the printing surface 71 to the collision avoiding position (step #96). For flushing and wiping, the controller 10 may make the head 8 move to the maintenance device 9. Next, the controller 10 confirms whether or not printing has been completed with respect to the entire fabric 7 (step #97). In other words, the controller 10 confirms whether or not printing has been completed with respect to one whole roll of the fabric 7. When printing has not been completed (No in step #97), the flow returns to step #93. During printing in a next unit printing range E1, the press processing is performed again. When printing is completed (Yes in step #97), the present flow ends (END). When the present flow has ended, the controller 10 may put the cap 91 on the head 8 after performing flushing or wiping.

In this manner, the ink discharge devices 1 according to the embodiment and the modified example are attachable to and detachable from the conveyance line which is for a recording medium (such as the fabric 7) conveyed by the conveyance device 3 and which is provided with the plate device 2 which performs printing by using a plate. Here, the ink discharge device 1 may be fixed to the conveyance line which is for a recording medium (such as the fabric 7) conveyed by the conveyance device 3 and which is provided with the plate device 2 which performs printing using a plate. The ink discharge device 1 includes the head 8, the movement unit 12, and the controller 10. The head 8, based on the image data D2, prints an image by making the nozzles 81 discharge ink to the printing surface 71 of a recording medium conveyed by the conveyance device 3. The movement unit 12 moves the head 8 at least in two axial directions. The controller 10 controls the movement unit 12. One of the two axial directions is the Y-axis direction, which is, when the printing surface 71 of the recording medium is taken as the front face, the conveyance direction in which the recording medium is conveyed.

According to this configuration, the position of the head 8 can be moved at least in two axial directions. The position of the head 8 can be moved in the Y-direction of the fabric 7. The position of the head 8 can be freely changed in a plane. Accordingly, the position of the head 8 can be adjusted easily. Since the position of the head 8 can be moved freely, the head 8 can be moved to a position that allows easy maintenance operations such as wiping and replacement. This facilitates maintenance of the head 8, and helps reduce operational burden on the user. Further, image printing can be performed while moving the head 8 in the Y-axis direction of the fabric 7.

The printing device 100 includes at least the ink discharge device 1 according to the embodiment, the conveyance device 3 which conveys the fabric 7, and the plate device 2 which performs printing by using a plate with respect to the fabric 7 conveyed by the conveyance device 3. The provision of the plate device 2, which performs printing by using a plate, makes it possible to provide a printing device 100 that can offer the advantages of both the inkjet printing and the printing with a plate. For example, it is possible to provide a printing device 100 that performs printing of a fine design or gradation in a plurality of colors by using an inkjet discharge device. Since printing can be normally performed in one color by using one plate, in comparison with a case where only plates are used, similar printing can be performed by using a smaller number of pates. On the other hand, in a case where printing is performed with respect to the fabric 7 by using inkjet alone, a desired density may be difficult to be achieved or color unevenness may be caused. With respect to a part, such as a solid part, where color unevenness should be avoided, a plate can be used for printing. Thus, it is possible to provide a high image-quality printing device 100.

The head 8 includes the nozzle arrays 80 each including the nozzles 81 arranged along the Y-axis direction. The nozzle arrays 80 are parallel to the conveyance direction. The movement unit 12 includes the first movement mechanism A, the second movement mechanism B, and the third movement mechanism C. The controller 10, in the Z-axis direction, which is a height direction when the printing surface 71 of a recording medium is taken as the front face, makes the first movement mechanism A move the head 8. The controller 10, in the X-axis direction, which is a direction perpendicular to the conveyance direction of the recording medium when the printing surface 71 of the recording medium is taken as the front face, makes the second movement mechanism B move the head 8. The controller 10, in the Y-axis direction, makes the third movement mechanism C move the head 8. By three-dimensionally moving the head 8 with respect to the fabric 7, it is possible to move the head 8 in three directions, namely, the direction perpendicular to the Y-axis direction of the fabric 7 (the perpendicular direction), the Y-axis direction, and a depth direction. The head 8 can be moved to a desired position. The head 8 can be moved freely to a position where it is easy to perform maintenance of the head 8. The operational burden on the user can be reduced. Further, it is possible to print an image while keeping the fabric 7 stationary.

The ink discharge device 1 may be placed at a position on an upstream side of the plate device 2 in the Y-axis direction. Printing with a plate can be performed with respect to the fabric 7 where printing has been performed by using the inkjet discharge device. Just by providing the ink discharge device 1 upstream of the already provided plate device 2, it is possible to achieve the printing device 100 capable of performing both inkjet printing and printing with a plate.

Or, the ink discharge device 1 may be provided at a position, in the Y-axis direction, on a downstream side of the plate device 2 or between a plurality of plate devices 2. Printing by an inkjet discharge device can be performed with respect to the fabric 7 where printing has been performed with a plate. Just by providing the ink discharge device 1 midstream or downstream of the plate device 2, it is possible to achieve the printing device 100 capable of performing both inkjet printing and printing with a plate.

The printing device 100 (the ink discharge device 1) is provided with the maintenance device 9 which is provided within the moving range of the head 8 but outside the upper surface of the recording medium. The maintenance device 9 includes the cap 91. When, of the head 8, the exposure face, at which the nozzles 81 are exposed, is fitted in the cap 91, the cap 91 prevents ink from drying up. When the predetermined retraction condition is satisfied, the controller 10 makes the movement unit 12 move the head 8 toward the retraction position. When the head 8 is at the retraction position, the head 8 is fitted in the cap 91. In this manner, fitting of the head 8 in the cap 91 provided for preventing ink from drying up can be automated. There is no need of manually putting the cap 91 on the head 8 to prevent ink from drying up. In a case of a fixed printing head or in a case of a printing head movable only in a direction perpendicular to the Y-axis direction, to achieve automated fitting of the cap 91 for preventing ink from drying up, equipment and mechanism remodeling was needed in an inkjet printing machine. According to the printing device 100, such remodeling is no longer necessary. Thus, it is possible to provide the printing device 100 of which maintenance is easy.

The printing device 100 (the ink discharge device 1) includes the operation panel 15 which accepts an operation. The retraction condition is one, or two or more, of the following: the operation panel 15 having accepted an instruction to retract the head 8; the predetermined retraction time having come; and printing having been completed. Based on a predetermined trigger, the cap 91 can be automatically attached to the head 8. A trigger can be set for the automatic attachment of the cap 91 to the head 8. The cap 91 can be automatically attached to the head 8 in association with a time point, such as a lunch break, when the line is suspended. The cap 91 can be automatically attached to the head 8 at a time point when printing is completed.

The wiping of the head 8 (the nozzles 81) has conventionally been performed manually. For example, an operator performs an operation of removing highly viscous ink, foreign particles, etc., from the nozzles 81 with a blade. The maintenance device 9 includes the cleaning member 92 for wiping the nozzles 81. When the predetermined wiping condition has been satisfied, the controller 10 makes the movement unit 12 move the head 8 to have the nozzles 81 rubbed by the cleaning member 92. The wiping (wiping operation) of the head 8 can be automated. Causes of clogging of the nozzles 81 can be automatically removed. The clogging is caused by ink (highly viscous ink) that has dried up to be less flowable, dust, foreign particles, etc. There is no need of manually rubbing the nozzle-81 face of the head 8. To achieve automated operation of wiping the head 8, equipment and the mechanism remodeling was needed. Remodeling of a device related to printing (for example, a device for conveying the fabric 7) is no longer necessary to achieve the automation. Accordingly, it is possible to provide the printing device 100 of which maintenance is easy.

The wiping condition is one, or two or more, of the following: the operation panel 15 having accepted an instruction to wipe the head 8; the predetermined wipe time having come; the cap 91 not having being fitted for a predetermined continuous time after the start of printing or after the previous wiping; printing having been performed with respect to a recording medium; and printing having been completed. Based on a predetermined trigger, the wiping operation can be started automatically. A trigger can be set for automatic start of wiping. Wiping can also be performed automatically in association with a time point, such as a lunch break, when the line is stopped. The wiping of the head 8 can also be performed automatically after continuous printing with respect to the fabric 7. The wiping of the head 8 can also be performed automatically at a time point when printing is completed.

The printing device 100 (the ink discharge device 1) includes the washer 93 which pours a washing solution on the cleaning member 92 before the cleaning member 92 rubs the nozzles 81, and washes the cleaning member 92 with the washing solution after the wiping. The washing solution can be applied to the cleaning member 92 before it rubs the nozzles 81. This helps reduce a friction coefficient of the cleaning member 92 and helps prevent damage to the nozzles 81. Moreover, the cleaning member 92 can always be kept clean. Thus, dirt having been collected on the cleaning member 92 during wiping will not adhere to the nozzles 81 (the head 8) in the next wiping.

The printing device 100 (the ink discharge device 1) includes the pressurization unit 85 which applies pressure to ink within the head 8. The maintenance device 9 includes the opening 95 which is larger in area than the exposure face and leads to the exhaust liquid tank 94. When a predetermined purging condition is satisfied, the controller 10 makes the movement unit 12 move the head 8 such that the entire exposure face faces the opening 95. The controller 10 makes the pressurization unit 85 apply pressure to the ink within the head 8. The wiping (purging) of the head 8 can be automated. During the purging, the ink is pushed out of the nozzles 81 by the pressurization unit 85. This helps discharge (eject) what is stuck in the nozzles 81 to outside the nozzles 81. A solid substance resulting from drying up of ink, dust, foreign particles, etc. can be removed. Clogging trouble of the nozzles 81 can be cleared easily. Accordingly, it is possible to provide the printing device 100 of which maintenance is easy.

When the predetermined flushing condition is satisfied, the controller 10 makes the movement unit 12 move the head 8 such that the entire exposure surface faces the opening 95. The controller 10 makes all of the nozzles 81 discharge ink toward the opening 95. The processing of flushing the head 8 can be automated. Causes of clogging of the nozzles 81 can be automatically discharged (blown off). The clogging is caused by ink (highly viscous ink) that has dried up to be less flowable, dust, foreign particles, etc. There is no need of manually rubbing the nozzle-81 face of the head 8. Accordingly, it is possible to provide the printing device 100 in which clogging of the nozzles 81 is easily prevented and of which maintenance is easy.

The flushing condition is one, or two or more, of the following: the conveyance of a recording medium having been stopped; printing having been completed; and a predetermined time having elapsed from the start of printing or from the previous flushing processing. Based on a predetermined trigger, the flushing processing can be started automatically. A trigger can be set for the automatic flushing processing. The head 8 can also be wiped automatically in association with a time point when the conveyance line for conveying the fabric 7 is stopped.

The ink discharge device 1 according to the embodiment is attachable to and detachable from the conveyance line which is provided with the plate device 2 for performing printing by using a plate and which is for a recording medium conveyed by the conveyance device 3. The ink discharge device 1 includes the head 8, the movement unit 12, and the controller 10. The head 8, based on the image data D2, discharges ink from the nozzles 81 to the printing surface 71 of the recording medium conveyed by the conveyance device 3, and thereby prints an image. The movement unit 12 makes the head 8 move in the Z-axis direction, which is the height direction when the printing surface 71 of the recording medium is taken as the front face. The head 8 is moved at least in two axial directions. The controller 10, in accordance with the image to be printed, sets the discharge-time distance, which is a distance between the nozzles 81 and the printing surface 71 during ink discharge, and makes the movement unit 12 move the head 8 in the Z-axis direction to achieve the discharge-time distance.

According to this configuration, the distance between the head 8 (the nozzles 81) and the fabric 7 (the printing surface 71) can be automatically adjusted. For example, in accordance with an image to be printed or the fabric 7, the head 8 can be automatically moved to an appropriate position in the Z-axis direction. What is more, it is possible to provide the printing device 100 which includes the plate device 2 for printing by using a plate and thus has the advantages of both the inkjet printing and the printing with a plate.

The controller 10 sets the discharge-time distance based on the printing setting information associated with the image data D2 to be used for printing of an image. Thereby, in the printing device 100, based on the image data D2 and the printing setting information D3, an appropriate distance can be automatically achieved between the nozzles 81 and the printing surface 71.

The ink discharge device 1 includes the storage medium 11 which stores therein the definition data D4 which defines the discharge-time distance for each image type. When the printing setting information D3 includes information indicating an image type, the controller 10 sets the discharge-time distance based on the image type included in the printing setting information D3, and the definition data D4. Based on the definition data D4, the type of the image to be printed can be recognized. In accordance with the type of the image to be printed, an appropriate distance can be automatically provided between the nozzles 81 and the printing surface 71. When the image is an image of a type that needs to be printed precisely and with a high quality, a relatively short distance can be automatically set between the nozzles 81 and the printing surface 71. When the image is an image of a type that does not need to be printed precisely or with a high quality, a relatively long distance can be automatically set between the nozzles 81 and the printing surface 71.

When the printing setting information D3 includes information indicating a a value of the discharge-time distance, the controller 10 sets the discharge-time distance based on the value included in the printing setting information D3. The distance between the nozzles 81 and the printing surface 71 can be made equal to the value directly defined by the printing setting information D3. The distance between the nozzles 81 and the printing surface 71 can be adjusted based on a value defined in advance.

The printing device 100 (the ink discharge device 1) includes the storage medium 11 which stores therein the definition data D4 which defines a distance for each image type. The controller 10 analyzes the image data D2, and judges the type of the image of the image data D2. The controller 10 sets the discharge-time distance based on the judged image type and the definition data D4. Through the analysis of the image data D2, the type of the image to be printed can be recognized. In accordance with the type of the image to be printed, an appropriate distance can be automatically achieved between the nozzles 81 and the printing surface 71. When the image is an image of a type that requires precise and high-quality printing, a relatively short distance can be automatically set between the nozzles 81 and the printing surface 71. When the image is an image of a type that does not require precise and high-quality printing, a relatively long distance can be automatically set between the nozzles 81 and the printing surface 71.

The printing device 100 (the ink discharge device 1) includes the storage medium 11 which stores therein the definition data D4 which defines the discharge-time distance for each image type. The printing device 100 (the ink discharge device 1) includes the operation panel 15 which accepts the selection of the type of an image to be printed. The controller 10 sets the discharge-time distance based on the image type selected via the operation panel 15, and the definition data D4. The user can set, via the operation panel 15, how precisely an image should be printed. In a case where it is desired to minimize displacement of ink impact positions, the distance can be set to be relatively short. In a case where displacement of ink impact positions would not cause any inconvenience, the distance can be set to be relatively long. Accordingly, the user can set the distance between the nozzles 81 and the printing surface 71 to a desired distance.

The selectable image types include a symbol string and a code image. When the symbol string has been selected as the image type, the controller 10 sets the discharge-time distance to the first distance. When the code image has been selected as the image type, the controller 10 sets the discharge-time distance to the second distance which is shorter than the first distance. The user can select the discharge-time distance in accordance with an image to be printed. Just by selecting the type of the image, the distance between the nozzles 81 and the printing surface 71 can be set so that a desired printing result can be obtained.

When the fabric 7 has a smooth surface, as the distance between the nozzles 81 and the printing surface 71 is shorter, it becomes more likely that a high-quality image can be printed. This is because the ink impact positions are not displaced and the ink is put uniformly on the surface of the fabric 7. On the other hand, when the fabric 7 has a rough surface, it can be preferable for the nozzles 81 and the printing surface 71 to be spaced from each other by a certain distance or more. As the distance between the nozzles 81 and the printing surface 71 is increased, it becomes more likely that the ink impact positions are scattered. There is a case where, thanks to the scattering of the ink impact positions, ink can be put along the unevenness of the surface. Thus, the printing device 100 (the ink discharge device 1) includes the operation panel 15 which accepts the setting of the smoothness level of the surface of a recording medium. The controller 10 makes the discharge-time distance shorter as the set smoothness level is higher. The controller 10 makes the discharge-time distance longer as the set smoothness level is lower. The distance between the nozzles 81 and the printing surface 71 can be set in accordance with the smoothness of the surface of the fabric 7. When the surface is smooth, the distance can be relatively short. On the other hand, when the surface is rough, the distance can be relatively long. For improvement of image quality in accordance with the state of the printing surface 71 of the fabric 7, the distance can be adjusted.

As the distance between the nozzles 81 and the printing surface 71 is longer, the ink impact positions are displaced more from the target positions. Thus, there is a tendency that, even with the same amount of ink discharged, the density of an image tends to be lower as the distance is longer. Thus, the controller 10 makes the head 8 discharge ink such that as the discharge-time distance is shorter, the ink discharge amount per dot is reduced. The controller 10 makes the head 8 discharge ink such that as the discharge-time distance is longer, the ink discharge amount per dot is increased. In accordance with the distance between the nozzles 81 and the printing surface 71, the amount of ink to be discharged from the nozzles 81 can be adjusted. An image that is neither too dense nor too thin can be printed on the printing surface 71.

The ink discharge device 1 is attachable to and detachable from the conveyance line which is provided with the plate device 2 for performing printing by using a plate and which is for a recording medium conveyed by the conveyance device 3. The ink discharge device 1 includes the head 8, the movement unit 12, and the controller 10. The head 8, based on the image data D2, discharges ink from the nozzles 81 to the printing surface 71 of the recording medium conveyed by the conveyance device 3, and thereby prints an image. The movement unit 12 makes the head 8 move in the Y-axis direction, which is the conveyance direction of the recording medium when the printing surface 71 of the recording medium is taken as the front face. The head 8 is moved at least in two axial directions. The controller 10 controls the movement unit 12 so as to perform printing with respect to the recording medium while moving the head 8 in the Y-axis direction.

According to this configuration, the position of the head 8 can be moved in the Y-axis direction of the fabric 7. The position of the head 8 can be freely changed in a plane. Accordingly, the position of the head 8 can be adjusted easily. Since the position of the head 8 can be moved freely, the head 8 can be moved to a position at which it is easy to perform maintenance operations such as wiping and replacement. Maintenance of the head 8 is easy.

Further, in a case of using a plate, the conveyance of the fabric 7 is temporarily suspended for printing. Since the head 8 is movable in the Y-axis direction of the fabric 7, printing can be performed by using the ink discharge device 1 even while printing is being performed by using the plate. Since the head 8 is movable in the Y-axis direction, printing can be performed with respect to the fabric 7 even while the fabric 7 is being conveyed. It is possible to provide the printing device 100 which is high in printing speed and productivity. What is more, since the printing device 100 includes the plate device 2 for printing by using a plate, it is possible to provide the printing device 100 which has the advantages of both the inkjet printing and the printing with a plate.

The conveyance device 3 stops conveying the recording medium each time it conveys the recording medium by the prescribed distance F1. The ink discharge device 1 performs printing with respect to the recording medium in the stationary state. When printing by the head 8 is completed, the conveyance device 3 restarts to convey the recording medium. In association with the completion of printing by the ink discharge device 1 with respect to the fabric 7 (printing in a unit printing range E1) in the stationary state, the conveyance of the fabric 7 can be restarted.

For printing with respect to the recording medium in the stationary state, the controller 10 makes the movement unit 12 move the head 8 in the Y-axis direction and in the X-axis direction, which is a direction that is perpendicular to the conveyance direction of the recording medium when the printing surface 71 of the recording medium is taken as the front face. Printing can be performed with respect to the fabric 7 while moving the head 8 both in the Y-axis direction and in the direction perpendicular to the Y-axis direction. Unlike in the conventional technology which allows the head 8 to move only in the direction perpendicular to the Y-axis direction, a higher degree of freedom can be achieved in printing.

The head 8 includes the nozzle arrays 80 each including the plurality of nozzles 81 arranged along the Y-axis direction. During printing with respect to the recording medium in the stationary state, the controller 10 repeats scanning by moving the head 8 in the X-axis direction. The controller 10 makes the head 8 discharge ink during the scanning. After one event of scanning is completed, the controller 10 makes the head 8 move in the Y-axis direction by the predetermined width G1. After the movement of the head 8 in the Y-axis direction by the predetermined width G1 is completed, the controller 10 makes the movement unit 12 start next scanning. The nozzle arrays 80 are parallel to the Y-axis direction, and since, during printing, scanning is repeated by making the head 8 move in the X-axis direction, positions of nozzles, of the nozzles 81, from which ink is discharged are different in each event of scanning. Thereby, of the nozzles 81, the number of nozzles that do not discharge ink can be reduced. This helps reduce occurrence of drying up of ink and reduce the number of such nozzles of the nozzles 81 as become unable to discharge ink due to dried ink.

The ink discharge device 1 performs printing with respect to the fabric 7 under conveyance. For printing with respect to a recording medium under conveyance, the controller 10 moves the position of the head 8 in the Y-axis direction and in the X-axis direction, which is perpendicular to the conveyance direction of the recording medium when the printing surface 71 of the recording medium taken as the front face. Use of the ink discharge device 1 makes it possible to perform printing with respect to the fabric 7 while the fabric 7 is conveyed. Printing can be performed with respect to the fabric 7 while moving the head 8 in the X-axis direction and in the Y-axis direction.

The head 8 includes the nozzle arrays 80 each including the plurality of nozzles 81 arranged along the Y-axis direction. For printing with respect to a recording medium under conveyance, the controller 10 repeats scanning by moving the head 8 in the X-axis direction. The controller 10 makes the head 8 discharge ink during the scanning. During the scanning, the controller 10 makes the movement unit 12 move the head 8 in the Y-axis direction such that a relative speed between the recording medium and the head 8 in the Y-axis direction is zero. After one event of scanning is completed, the controller 10 makes the movement unit 12 move the head 8 in the Y-axis direction such that the amount of movement in the Y-axis direction with respect to the recording medium that is being conveyed becomes equal to the predetermined width G1. After the movement by the amount equal to the predetermined width G1 is completed, the controller 10 makes the movement unit 12 start next scanning. During one event of scanning, ink can be discharged with the relative speed between the fabric 7 and the head 8 in the Y-axis direction fixed. Even when printing is performed with respect to the fabric 7 under conveyance by using the ink discharge device 1, printing-position displacement is not caused. Printing can be performed with relative positions of the fabric 7 and the head 8 each displaced by the predetermined width G1 in the Y-axis direction.

The printing device 100 (the ink discharge device 1) includes the speed sensor 14 for detecting the moving speed of a recording medium in the Y-axis direction. The controller 10 recognizes the moving speed based on the output of the speed sensor 14. During scanning, in the Y-axis direction, the controller 10 makes the movement unit 12 move the head 8 at the recognized moving speed. By making the fabric 7 and the head 8 move at the same speed, it is possible to prevent displacement of printing positions even when printing is performed while conveying the fabric 7.

In a case where the length of the nozzle arrays 80 is represented by A, the printing resolution is represented by B, and the number of nozzles included in the unit length of each nozzle array 80 is represented by C, the predetermined width G1 is equal to (A÷(B÷C))+1 dot. Even when the number of nozzles per unit length is smaller than the number of dots per unit length (1 inch) of the printing resolution, the number of times of ink discharge (the amount of ink droplets) per unit area can be made equivalent to the printing resolution.

The printing device 100 (the ink discharge device 1) includes the reading device 18 which reads the printing surface 71 and generates the shot image data D7. The controller 10 judges whether or not a specification image is included in the shot image data D7. When judging that a specific image is included, the controller 10 makes the head 8 print an image corresponding to the specific image. By marking the fabric 7 with the specification image in advance, the image corresponding to the specification image can be automatically printed on the fabric 7. This helps reduce setting operations related to the printing with respect to the fabric 7.

The controller 10 judges whether or not a specification mark is included in the shot image data D7. When judging that a specification mark is included in the shot image data D7, the controller 10 makes the head 8 print an image corresponding to the specification mark. By marking the fabric 7 with the specification mark in advance, the image corresponding to the specification mark can be automatically printed on the fabric 7. The mark may be hand drawn as long as it is recognizable. The mark may be a seal. This helps reduce setting operations related to the printing with respect to the fabric 7.

Based on shot image data obtained by shooting an image of a sample of a recording medium, the controller 10 generates the image data D2 to be used for printing. Based on the image data D2 generated based on the shot image data, the controller 10 makes the head 8 perform printing with respect to the recording medium. A copy of the sample can be printed on the fabric 7. Copy printing of a symbol or a code marked on the sample can be performed. This helps reduce setting operations related to the printing with respect to the fabric 7.

The ink discharge device 1 is attachable to and detachable from the conveyance line which is provided with the plate device 2 for performing printing by using a plate, and which is for a recording medium conveyed by the conveyance device 3. The ink discharge device 1 includes the head 8, the movement unit 12, and the controller 10. The head 8, based on the image data D2, discharges ink from the nozzles 81 to the printing surface 71 of the recording medium conveyed by the conveyance device 3, and thereby prints an image. The movement unit 12 makes the head 8 move in the Z-axis direction, which is the height direction when the printing surface 71 of the recording medium is taken as the front face. The head 8 is moved at least in two axial directions. The controller 10 controls the movement unit 12. The controller 10 sets the discharge-time distance, which is a distance between the nozzles 81 and the printing surface 71 of the recording medium. The controller 10 makes the movement unit 12 move the head 8 in the Z-axis direction. The distance between the nozzles 81 and the printing surface 71 is maintained at the set discharge-time distance.

With this configuration, the head 8 can be moved with respect to the printing surface 71 in the Z-axis direction. By the movement of the head 8, a constant distance can be maintained between the head 8 (the nozzles 81) and the fabric 7 (the printing surface 71) during printing. Accordingly, it is possible to eliminate quality variation among printed images. For example, it is possible to prevent printing of an image with color unevenness and a blurred image. What is more, the plate device 2 for printing by using a plate is provided, and thus it is possible to provide the printing device 100 which has the advantages of both the inkjet printing and the printing with a plate.

The printing device 100 (the ink discharge device 1) includes the distance sensor 17 for measuring the distance between the nozzles 81 and the printing surface 71. The controller 10 recognizes a distance based on the output of the distance sensor 17. Before starting printing of an image, the controller 10 performs the position adjustment processing. In the position adjustment processing, the controller 10 makes the movement unit 12 move the head 8 in the Z-axis direction. The controller 10 makes the distance equal to the set discharge-time distance. During printing, based on the output of the distance sensor 17, the controller 10 makes the movement unit 12 move the head 8 in the Z-axis direction such that the distance is maintained at the discharge-time distance. By using the sensor, a constant distance (interval) can be maintained between the nozzles 81 and the printing surface 71 during printing. Quality variation among printed images can be eliminated.

After printing is completed in a unit printing range E1 determined in advance, the controller 10 makes the movement unit 12 move the head 8 in the Z-axis direction to increase the distance. The controller 10 has the head 8 moved to the collision avoiding position. Before starting printing in a next unit printing range E1, the controller 10 makes the movement unit 12 move the head 8 in the Z-axis direction to reduce the distance. After printing is completed with respect to the fabric 7, the head 8 can be retracted to a safe position. When starting printing with respect to the fabric 7 under conveyance, the head 8 can be made to approach the fabric 7. Collision between the head 8 and the fabric 7 can be eliminated.

The ink discharge device 1 includes the distance regulation member 110 for preventing the distance from becoming equal to or shorter than the reference distance. The distance regulation member 110 projects more than the nozzles 81 in the Z-axis direction toward the position where the recording medium is located. The distance regulation member 110 helps prevent the distance between the nozzles 81 and the printing surface 71 from becoming equal to or shorter than the reference distance. It is possible to protect the head 8 (the nozzles 81) from damage that could be caused by the head 8 and the fabric 7 colliding with each other.

The distance regulation member 110 is attached to the head 8. The distance regulation member 110 can be moved together with the head 8. Regardless of the position of the head 8, the distance between the nozzles 81 and the printing surface 71 can be prevented from becoming equal to or shorter than the reference distance.

The distance regulation member 110 is a roller or a ball. Along with the movement of the head 8, the distance regulation member 110 can be moved smoothly in contact with the fabric 7. The distance regulation member 110 can be moved along the shape of the fabric 7 without damaging the fabric 7.

The distance regulation member 110 includes the contact sensor 111 for detecting contacting of the distance regulation member 110 with the recording medium. The contact sensor 111 outputs the first level when the distance regulation member 110 is in contact with the recording medium. The contact sensor 111 outputs the second level when the distance regulation member 110 is out of contact with the recording medium. The controller 10 performs the press processing before starting printing of an image. During the press processing, the controller 10 makes the movement unit 12 move the head 8 in the Z-axis direction until the output of the contact sensor 111 changes from the second level to the first level. This helps prevent pressure between the distance regulation member 110 and the fabric 7 from becoming excessively strong. The distance regulation member 110 is kept from being pressed against the fabric 7 too strongly. This helps prevent the distance between the nozzles 81 and the printing surface 71 from becoming equal to or shorter than the reference distance. Since the distance regulation member 110 does not come in strong contact with the fabric 7, it does not cause any damage to the fabric 7.

After printing in the unit printing range E1 determined in advance is completed, the controller 10 makes the movement unit 12 move the head 8 in the Z-axis direction to increase the distance. The controller 10 moves the head 8 to the collision avoiding position. Before starting printing in a next unit printing range E1, the controller 10 makes the movement unit 12 move the head 8 in the Z-axis direction to reduce the distance, until the output of the contact sensor 111 changes from the second level to the first level. After printing with respect to the fabric 7 is completed, the head 8 and the distance regulation member 110 are retracted to a position at which they never contact the fabric 7, whereby the head 8 and the distance regulation member 110 can be retracted to a safe position. When starting printing in a unit printing range E1, the distance regulation member 110 is brought into contact with the fabric 7 again to prevent the head 8 and the fabric 7 from colliding with each other.

The range of the present invention is shown not by the above descriptions of the embodiments but by the scope of claims for patent, and it is intended that all modifications within the meaning and range equivalent to the scope of claims for patent are included.

### INDUSTRIAL APPLICABILITY

The present invention is usable in printing devices that perform printing with respect to fabric, paper, etc., by using an ink discharge device and a plate device.

1. An ink discharge device attached to a conveyance line which conveys a recording medium by using a conveyance device and which is provided with a plate device which performs printing by using a plate, the ink discharge device comprising:
a head which prints an image based on image data by discharging ink from a nozzle to a printing surface of the recording medium conveyed by the conveyance device;
a movement unit which makes the head move in a Z-axis direction which is a height direction when the printing surface of the recording medium is taken as a front face, and which moves the head at least in two axial directions; and
a controller which, in accordance with an image to be printed or the recording medium, sets a discharge-time distance which is a distance between the nozzle and the printing surface during ink discharge, and which makes the movement unit move the head in the Z-axis direction to achieve the discharge-time distance set.

2. The ink discharge device according to claim 1,
wherein
the ink discharge device is attachable to and detachable from the conveyance line, or the ink discharge device is fixed to the conveyance line.

3. The ink discharge device according to claim 1,
wherein
the head includes a nozzle array which includes a plurality of nozzles arranged along a conveyance direction,
the nozzle array is parallel to the conveyance direction,
the movement unit includes a first movement mechanism, a second movement mechanism, and a third movement mechanism, and
the controller
makes the first movement mechanism move the head in the Z-axis direction,
makes the second movement mechanism move the head in an X-axis direction which is perpendicular to the conveyance direction of the recording medium when the printing surface of the recording medium is taken as the front face, and
makes the third movement mechanism move the head in a Y-axis direction which is the conveyance direction of the recording medium when the printing surface of the recording medium is taken as the front face.

4. The ink discharge device according to claim 1,
wherein
the controller sets the discharge-time distance based on printing setting information which is associated with the image data used for printing an image.

5. The ink discharge device according to claim 4, further comprising a storage medium which stores therein definition data which defines the discharge-time distance for each image type,
wherein
when the printing setting information includes information indicating an image type, the controller sets the discharge-time distance based on the definition data and the image type included in the printing setting information.

6. The ink discharge device according to claim 4,
wherein
when the printing setting information includes information indicating a value of the discharge-time distance, the controller sets the discharge-time distance based on the value included in the printing setting information.

7. The ink discharge device according to claim 4, further comprising a storage medium which stores therein definition data which defines the discharge-time distance for each image type,
wherein
the controller
analyzes the image data to judge an image type of the image data, and
sets the discharge-time distance based on the image type judged and the definition data.

8. The ink discharge device according to claim 1, further comprising:
a storage medium which stores therein definition data which defines the discharge-time distance for each image type; and
an operation panel which accepts selection of an image type of an image to be printed,
wherein
the controller sets the discharge-time distance based on the image type selected via the operation panel and the definition data.

9. The ink discharge device according to claim 8,
wherein
selectable image types include a symbol string and a code image, and
the controller
sets the discharge-time distance to a first distance when the symbol string is selected, and
sets the discharge-time distance to a second distance, which is shorter than the first distance, when the code image is selected.

10. The ink discharge device according to claim 1, further comprising an operation panel which accepts setting of a smoothness level of a surface of the recording medium,
wherein
the controller
reduces the discharge-time distance as the smoothness level set is higher, and
increases the discharge-time distance as the smoothness level set is lower.

11. The ink discharge device according to claim 1,
wherein
the controller
makes the head discharge a smaller amount of ink per dot as the discharge-time distance is shorter, and
makes the head discharge a larger amount of ink per dot as the discharge-time distance is longer.

12. A printing device comprising:
the ink discharge device according to claim 1;
the conveyance device which conveys a fabric; and
the plate device which performs printing by using a plate with respect to the fabric conveyed by the conveyance device.

13. A method for controlling an ink discharge device attached to a conveyance line which conveys a recording medium by using a conveyance device and which is provided with a plate device which performs printing by using a plate, the method comprising:
printing an image based on image data by discharging ink from a nozzle to a printing surface of the recording medium conveyed by the conveyance device;
moving a head of the ink discharge device in a Z-axis direction which is a height direction when the printing surface of the recording medium is taken as a front face;
moving the head at least in two axial directions;
setting, in accordance with an image to be printed or the recording medium, a discharge-time distance which is a distance between the nozzle and the printing surface during ink discharge; and
moving the head in the Z-axis direction to achieve the discharge-time distance set.
